(19) United States
(12) Patent Application Publication
(10) Pub. No.: US 2014/0195230 A1
(43) Pub. Date: Jul. 10, 2014

(54) DISPLAY APPARATUS AND METHOD FOR CONTROLLING THE SAME

(71) Applicant: SAMSUNG ELECTRONICS CO., LTD., Suwon-si (KR)

(72) Inventors: Sang-jin HAN, Gunpo-si (KR); Jae-kwon KIM, Suwon-si (KR); Eun-hee PARK, Guri-si (KR); So-yon YOU, Seoul (KR)

(73) Assignee: SAMSUNG ELECTRONICS CO., LTD., Suwon-si (KR)

(21) Appl. No.: 14/148,956

(22) Filed: Jan. 7, 2014

(30) Foreign Application Priority Data
Jan. 7, 2013 (KR) 10-2013-0001752

(51) Int. Cl. G10L 15/26

(52) U.S. Cl. CPC G10L 15/265
USPC 704/235

(57) ABSTRACT

A display apparatus is provided. The display apparatus includes: an output unit; a voice collector which collects a user's voice; a first communication unit which transmits the user's voice to a first server and receives text information which corresponds to the user's voice; a second communication unit which transmits the received text information to a second server; and a controller which, when response information which corresponds to the text information is received, controls the output unit to output a system response which corresponds to an utterance intention of the user based on the response information, and when the user's utterance intention is related to at least one of performance of a function of the display apparatus and a search for a content, the system response includes an additional question which relates to the at least one of the performance of the function and the search for the content.

### CROSS-REFERENCE TO RELATED APPLICATION

This application claims priority from Korean Patent Application No. 10-2013-0001752, filed on Jan. 7, 2013 in the Korean Intellectual Property Office, the disclosure of which is incorporated herein by reference in its entirety.

### BACKGROUND

1. Field

Methods and apparatuses consistent with exemplary embodiments relate to a display apparatus and a method for controlling the display apparatus, and more particularly, to a display apparatus which is controllable in accordance with a signal which relates to a user's voice and a method for controlling such a display apparatus.

2. Description of the Related Art

With the development of electronic technologies, various kinds of display apparatuses have been developed and distributed, and are equipped with a wide variety of functions in order to live up to the expectations of users. In particular, a television (TV) may be connected to the Internet and may provide Internet-based services, and users may view a number of digital broadcasting channels via a TV.

In recent years, technologies which use voice recognition have been developed in order to control the display apparatus more easily and intuitively. In particular, a TV is able to recognize a user's voice and perform a function which corresponds to the user's voice, such as controlling a volume or changing a channel.

However, related-art display apparatuses which are capable of recognizing a user's voice merely provide a function which corresponds to a recognized voice, but have limits with respect to providing interactive information by communicating with users.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a display apparatus which, when a user's utterance intention relates to at least one of performance of a function of the display apparatus and a search for a content, outputs an additional question which relates to the at least one of the performance of the function and the search for the content which corresponds to the user's utterance intention as a system response, and a method for controlling the same.

According to an aspect of an exemplary embodiment, there is provided a display apparatus including: an output unit; a voice collector which is configured to collect a signal which relates to a user's voice; a first communication unit which is configured to transmit the collected signal which relates to the user's voice to a first server and to receive text information which corresponds to the user's voice from the first server; a second communication unit which is configured to transmit the received text information to a second server; and a controller which, when response information which corresponds to the text information is received from the second server, is configured to control the output unit to output a system response which corresponds to an utterance intention of the user based on the response information, wherein, when the utterance intention of the user relates to at least one of a performance of a function of the display apparatus and a search for a content, the system response includes an additional question which relates to the performance of the function and the search for the content.

When the utterance intention of the user relates to the performance of the function of the display apparatus, the additional question may relate to confirming whether to perform the function.

When the utterance intention of the user relates to the performance of the function of the display apparatus which function requires a performance of a prior function prior to performing the function, the additional question may relate to the performance of the prior function.

When the utterance intention of the user relates to the search for the content, the additional question may relate to a potential result of the search for the content.

When the search for the content relates to an inquiry which relates a broadcast time of a first specific content, the additional question may relate to at least one of a search for the broadcast time of the first specific content and a search for a second specific content which is similar to the first specific content.

When the search for the content relates to a search for a person which relates to a first specific content, the additional question may relate to a search for a second specific content which relates to the person.

According to an aspect of another exemplary embodiment, there is provided a method for controlling a display apparatus, the method including: collecting a signal which relates to a user's voice; transmitting the collected signal which relates to the user's voice to a first server and receiving text information which corresponds to the user's voice from the first server; transmitting the received text information to a second server; and when response information which corresponds to the text information is received from the second server, outputting a system response which corresponds to an utterance intention of the user based on the response information, wherein, when the utterance intention of the user relates to at least one of performance of a function of the display apparatus and a search for a content, the system response includes an additional question which relates to the at least one of the performance of the function and the search for the content.

When the utterance intention of the user relates to the performance of the function of the display apparatus, the additional question may relate to confirming whether to perform the function.

When the utterance intention of the user relates to the performance of the function of the display apparatus which function requires a performance of a prior function prior to performing the function, the additional question may relate to the performance of the prior function.

When the utterance intention of the user relates to the search for the content, the additional question may relate to a potential result of the search for the content.

When the search for the content relates to an inquiry which relates to a broadcast time of a first specific content, the additional question may relate to at least one of a search for the broadcast time of the first specific content and a search for a second specific content which is similar to the first specific content.

When the search for the content relates to a search for a person which relates to a first specific content, the additional question may relate to a search for a second specific content which relates to the person.

According to various exemplary embodiments, because the users continuously communicate with the display apparatus by answering the additional questions, the users can obtain a result that is optimized for their respective intentions.

### BRIEF DESCRIPTION OF THE DRAWING FIGURES

The above and/or other aspects will be more apparent by describing in detail exemplary embodiments, with reference to the accompanying drawings, in which:

FIG. 1 is a view which illustrates an interactive system, according to an exemplary embodiment;

FIG. 2 is a block diagram which illustrates a display apparatus, according to an exemplary embodiment;

FIG. 3 is a block diagram which illustrates a detailed configuration of the display apparatus of FIG. 2;

FIG. 4 is a block diagram which illustrates a first server of FIG. 1;

FIG. 5 is a block diagram which illustrates a second server of FIG. 1;

FIGS. 6A, 6B, 6C, 7A, 7B, 7C, 7D, 8A, 8B, 8C, 8D, 9A, 9B, 9C, and 9D are views which illustrate respective examples of system responses which are output from a display apparatus, according to various exemplary embodiments; and

FIG. 10 is a flowchart which illustrates a method for controlling a display apparatus, according to an exemplary embodiment.

### DETAILED DESCRIPTION OF EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Further, functions or elements known in the related art are not described in detail, because they would obscure the exemplary embodiments with unnecessary detail.

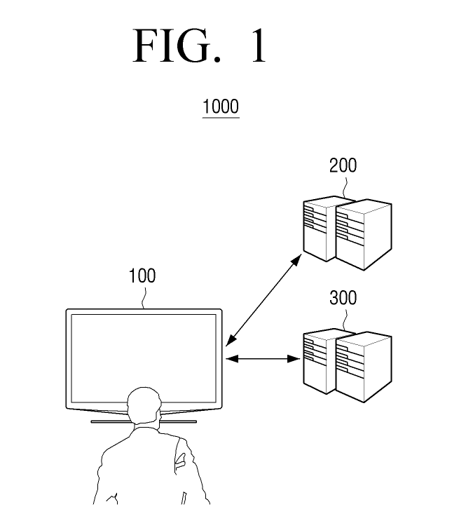

FIG. 1 is a view which illustrates an interactive system, according to an exemplary embodiment. As shown in FIG. 1, an interactive system 1000 includes a display apparatus 100, a first server 200, and a second server 300.

The display apparatus 100 may be controlled by use of a remote controller (not shown) which is adapted to control the display apparatus 100. Specifically, the display apparatus 100 may perform a function which corresponds to a remote control signal which is received from the remote controller (not shown). For example, when the display apparatus 100 is implemented by using a TV as shown in FIG. 1, the display apparatus 100 may perform a function such as, for example, a power on/off switching, changing a channel, and/or changing a volume, based on a received remote control signal.

In addition, the display apparatus 100 may perform any one or more of various operations which correspond to user's voices.

Specifically, the display apparatus 100 may perform a function which corresponds to a user's voice, or may output a system response which corresponds to a user's voice.

To achieve this, the display apparatus 100 transmits a collected signal which relates to a user's voice, such as, for example, a signal which includes information which relates to the user's voice, to the first server 200. When the first server 200 receives the signal which relates to the user's voice from the display apparatus 100, the first server 200 converts the received signal which relates to the user's voice into text information (that is, text) and transmits the text information to the display apparatus 100.

The display apparatus 100 transmits the text information which is received from the first server 200 to the second server 300. When the second server 300 receives the text information from the display apparatus 100, the second server 300 generates response information which corresponds to the received text information and transmits the response information to the display apparatus 100.

The display apparatus 100 may perform various operations based on the response information received from the second server 300.

The response information disclosed herein may include at least one of a control command for controlling the display apparatus 100 to perform a specific function, a control command for controlling the display apparatus 100 to output a system response, and system response information which relates to the system response which is output from the display apparatus 100.

Specifically, the display apparatus 100 may perform a function which corresponds to a user's voice. In particular, the display apparatus 100 may perform a function which corresponds to a user's voice from among the functions that can be provided by the display apparatus 100. For example, when a signal which relates to a user's voice which signal includes information which relates to “Please tune in to number ∘ (channel number)” is input, the display apparatus 100 may change a current channel to a channel ∘ based on a control command received from the second server 300. In this case, the second server 300 may transmit the control command for changing the channel to the channel ∘ to the display apparatus 100.

In addition, the display apparatus 100 may output a system response which corresponds to a user's voice. The system response may be output in at least one format from among a voice and a user interface (UI) screen.

For example, when a signal which relates to a user's voice which signal includes information which relates to inquiring about a broadcast time of a specific broadcast program is input, the display apparatus 100 may output the broadcast time of the specific broadcast program in at least one format from among a voice and a UI screen, based on system response information received from the second server 300. In this case, the second server 300 may transmit system response information which is expressed in a text format to the display apparatus 100.

Further, the display apparatus 100 may output the broadcast time of the specific broadcast program in at least one format from among the voice and the UI screen based on a control command received from the second server 300. In this case, the second server 300 may transmit the control command for controlling the display apparatus 100 to output the broadcast time of the broadcast program about which the user inquired to the display apparatus 100.

When an utterance intention of a user relates to at least one of performance of a function of the display apparatus 100 and a search for a content, the display apparatus 100 may output an additional question which relates to a performance of the function and the search for the content based on the user's utterance intention as a system response. In particular, the display apparatus 100 may output an additional question as a system response to the user's voice in order to execute a function that the user intends, or in order to output a system response that the user intends.

For example, it is assumed that a user's utterance intention is related to a performance of a function of the display apparatus 100. In this case, the display apparatus 100 may output, as a system response, an additional question which relates to receiving a confirmation as to whether to perform the function, or the display apparatus 100 may output an additional question which relates to a prior function when it is necessary to perform the prior function in order to perform the corresponding function.

For another example, when a user's utterance intention relates to a search for a content, the display apparatus 100 may output an additional question which relates to a potential result and/or an anticipated result of searching the content as a system response.

Besides these, the display apparatus 100 may output any one or more of various additional questions as system responses. Detailed exemplary embodiments in which the display apparatus 100 outputs additional questions will be described below with reference to the drawings.

Accordingly, because the users may continuously communicate with the display apparatus 100 by answering the additional questions, the users can obtain a result that is optimized for their respective intentions.

Although the display apparatus 100 of FIG. 1 is a TV, this is merely an example. In particular, the display apparatus 100 may be implemented by using various electronic apparatuses such as a mobile phone, a desktop personal computer (PC), a laptop computer, and a navigation system as well as the TV.

Further, although the first server 200 and the second server 300 are separate servers in FIG. 1, this is merely an example. In particular, a single interactive server which includes both of the first server 200 and the second server 300 may be implemented.

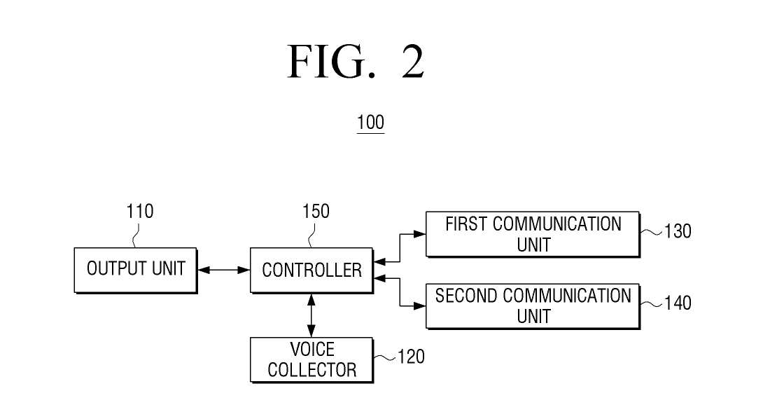

FIG. 2 is a block diagram which illustrates a display apparatus, according to an exemplary embodiment. As shown in FIG. 2, the display apparatus 100 includes an output unit 110, a voice collector 120, a first communication unit 130, a second communication unit 140, and a controller 150.

The output unit 110 outputs at least one of a voice and an image. Specifically, the output unit 110 may output a system response which corresponds to a signal which relates to a user's voice which is collected via the voice collector 120 in at least one format from among a voice and a graphic UI (GUI).

To achieve this, the output unit 110 may include a display (not shown) and an audio output unit (not shown).

Specifically, the display (not shown) may provide any one or more of various images that can be provided by the display apparatus 100. In particular, the display (not shown) may configure a UI screen which includes at least one of text, an image, an icon and a GUI, and may display a system response which corresponds to a user's voice on the UI screen. The display (not shown) may be implemented by using at least one of a liquid crystal display (LCD), an organic light emitting display (OLED), and a plasma display panel (PDP).

The audio output unit (not shown) may output a system response which corresponds to a user's voice in a voice format. The audio output unit (not shown) may be implemented by using an output port, such as, for example, a jack or a speaker.

The output unit 110 may output various contents. The content may include a broadcast content, a video on demand (VOD) content, and a DVD content. Specifically, the display (not shown) may output an image which constitutes the content and the audio output unit may output a sound which constitutes the content.

The voice collector 120 collects a signal which relates to a user's voice. For example, the voice collector 120 may be implemented by using a microphone to collect a signal which relates to a user's voice, and may be embedded in the display apparatus 100 as an integral type or may be separated from the display apparatus 100 as a standalone type. If the voice collector 120 is implemented by the standalone type, the voice collector 120 may have a shape that can be grasped by user's hand or can be placed on a table or a desk, and may be connected with the display apparatus 100 via a wired or wireless network, and may transmit a collected signal which relates to a user's voice to the display apparatus 100.

The voice collector 120 may determine whether the collected signal relates to a user's voice or not, and may filter noise (for example, a sound of an air conditioner or a vacuum cleaner, or a sound of music) from the collected signal.

For example, when information which relates to a user's voice of an analogue format is input, the voice collector 120 samples the input information which relates to the user's voice and converts a result of the sampling into a digital signal. The voice collector 120 calculates energy of the converted digital signal and determines whether the energy of the digital signal is greater than or equal to a predetermined value.

If the energy of the digital signal is greater than or equal to the predetermined value, the voice collector 120 removes a noise component from the digital signal and transmits the digital signal to the first communication unit 130. The noise component includes an unexpected noise that may be generated in a general home environment and may include at least one of a sound of an air conditioner, a sound of a vacuum cleaner, and a sound of music. Conversely, if the energy of the digital signal is less than the predetermined value, the voice collector 120 waits for another input without processing the digital signal separately.

Accordingly, because the whole audio processing operation is not activated by a sound other than a user's voice, unnecessary power consumption can be prevented.

The first communication unit 130 communicates with the first server 200 (see FIG. 1). Specifically, the first communication unit 130 may transmit the signal which relates to the user's voice to the first server 200 and may receive text information which corresponds to the user's voice from the first server 200. The first communication unit 130 may be implemented, for example, as a transmitter/receiver, a transceiver, and/or any device or component which is configured to transmit signals and receive signals.

The second communication unit 140 communicates with the second server 300 (see FIG. 1). Specifically, the second communication unit 140 may transmit the received text information to the second server 300 and may receive response information which corresponds to the text information from the second server 300. The second communication unit 140 may be implemented, for example, as a transmitter/receiver, a transceiver, and/or any device or component which is configured to transmit signals and receive signals.

To achieve this, the first communication unit 130 and the second communication unit 140 may communicate with the first server 200 and the second server 300 by using any one or more of various communication methods.

For example, the first communication unit 130 and the second communication unit 140 may communicate with the first server 200 and the second server 300, respectively, by using at least one of a wired/wireless local area network (LAN), a wide area network (WAN), Ethernet, Bluetooth, Zigbee, a universal serial bus (USB), IEEE 1394, and wireless fidelity (Wi-Fi). To achieve this, the first communication unit 130 and the second communication unit 140 may include a chip and/or an input port which corresponds to each communication method. For example, if communication is performed by using a wired LAN method, each of the first communication unit 130 and the second communication unit 140 may include a wired LAN card (not shown) and an input port.

Although the display apparatus 100 includes the separate communication units 130 and 140 to communicate with the first server 200 and the second server 300 in the above-described exemplary embodiment, this is merely an example. That is, the display apparatus 100 may communicate with the first server 200 and the second server 300 via a single communication module.

Further, although the first communication unit 130 and the second communication unit 140 communicates with the first server 200 and the second server 300 in the above-described exemplary embodiment, this is merely an example. That is, either or both of the first communication unit 130 and the second communication unit 140 may be connected to a web server (not shown) and may perform web browsing, or may be connected to a content provider server which provides a VOD service and may search for a VOD content.

The controller 150 controls an overall operation of the display apparatus 100. In particular, the controller 150 may control the operations of the output unit 110, the voice collector 120, the first communication unit 130, and the second communication unit 140. The controller 150 may include a read only memory (ROM) and a random access memory (RAM) which store a module and data for controlling a central processing unit (CPU) and the display apparatus 100.

Specifically, the controller 150 may control the voice collector 120 to collect a signal which relates to a user's voice and control the first communication unit 130 to transmit the collected signal which relates to the user's voice to the first server 200. When text information which corresponds to a user's voice is received from the first server 200, the controller 150 may control the second communication unit 140 to transmit the received text information to the second server 300.

Further, when response information which corresponds to the text information is received from the second server, the controller 150 may perform various operations based on the response information.

Specifically, the controller 150 may perform a function which corresponds to a user's utterance intention based on the response information.

The response information disclosed herein may include a control command for controlling a function of the display apparatus 100. Specifically, the control command may include a command for performing a function which corresponds to a user's voice from among functions that are executable in the display apparatus 100. Accordingly, the controller 150 may control the elements of the display apparatus 100 for performing the function which corresponds to the user's voice based on the control command which is received from the second server 300.

For example, when the display apparatus 100, which is implemented by using a TV, collects a signal which relates to a user's voice and contains information which relates to “Please tune in to number ∘ (channel number)”, the second server 300 may determine that the utterance intention of “Please tune in to number ∘ (channel number)” relates to a change of a channel to number ∘ (channel number), and may transmit a control command for changing the channel to number ∘ (channel number) based on the determined utterance intention to the display apparatus 100. Accordingly, the controller 150 may change the channel to number ∘ (channel number) based on the received control command, and may output a content which is provided on the changed channel.

However, this is merely an example. The controller 150 may control the elements of the display apparatus 100 to perform any one or more of various operations, such as, for example, power on/off or controlling a volume, based on a collected signal which relates to a user's voice.

Further, the controller 150 may control to output a system response which corresponds to a user's utterance intention based on response information.

The response information disclosed herein may include system response information for outputting a system response which corresponds to a user's voice on the display apparatus 100. In this case, the response information may further include a control command for outputting the system response which corresponds to the user's voice.

Specifically, the system response information may be a text format of the system response which is output from the display apparatus 100 in response to the user's voice.

Accordingly, the controller 150 may control the output unit 110 to output the system response which corresponds to the user's voice by using the received system response information.

For example, the controller 150 may configure a UI screen to include text which constitutes the received system response information and may output the UI screen via the display (not shown). Further, the controller 150 may convert the system response information of the text format into a sound by using a text to speech (TTS) engine, and may output the sound through the audio output unit (not shown). The TTS engine is a module for converting text into a voice signal. The controller 150 may convert the system response information of the text format to a voice signal by using any one or more of various TTS algorithms which are disclosed in the related art.

For example, when the display apparatus 100, which is implemented by using a TV, collects a signal which relates to a user's voice and includes information which relates to “When is ∘∘∘ (broadcast program name) aired?”, the second server 300 may determine that the utterance intention of “When is ∘∘∘ (broadcast program name) aired?” relates to an inquiry which relates to a broadcast time of ∘∘∘ (broadcast program name), may express a response which includes information which relates to “The broadcast time of ∘∘∘ (broadcast program name) which you inquired about is ∘ o'clock (broadcast time)” in a text format based on the determined utterance intention, and may transmit the response to the display apparatus 100.

In this case, the controller 150 may convert the response “The broadcast time of ∘∘∘ (broadcast program name) which you inquired about is ∘ o'clock (broadcast time)”, which is expressed in the text format, into a voice signal, and may output the voice signal via the audio output unit (not shown), or may configure a UI screen to include the text “The broadcast time of ∘∘∘ (broadcast program name) which you inquired about is ∘ o'clock (broadcast time)” and may output the UI screen via the display (not shown).

As described above, the controller 150 may perform a function which corresponds to a user's voice or may output a system response which corresponds to a user's voice.

When a signal which relates to a user's voice includes information which relates to an intention to perform a function that is not executable in the display apparatus 100, the display apparatus 100 may output a system response which corresponds to the user's voice without executing a separate function.

For example, it is assumed that the display apparatus 100 is implemented by using a TV that does not support a videotelephony function. In this case, when the display apparatus 100 collects a signal which relates to a user's voice which includes information relating to “Please call XXX”, the second server 300 may transmit a control command for performing a videotelephony function to the display apparatus 100. However, because the display apparatus 100 does not support the function which corresponds to the control command, the controller 150 may not recognize the control command received from the second server 300. In this case, the controller 150 may output a system response which includes information which relating to “This function is not supported” in at least one format from among a voice signal and a UI screen.

Although the second server 300 transmits system response information of a text format to the display apparatus 100 in order for the display apparatus 100 to output a system response in the above-described exemplary embodiment, this is merely an example.

In particular, the second server 300 may transmit voice data which constitutes a system response to be output from the display apparatus 100, or some of the voice data which constitutes the system response to the display apparatus 100. Further, the second server 300 may transmit a control command for outputting a system response using data which is pre-stored in the display apparatus 100 to the display apparatus 100.

Accordingly, the controller 150 may control to output the system response based on a format of the response information which is received from the second server 200.

Specifically, when voice data constituting a system response or some of the voice data is received, the controller 150 may process the data in a format which is outputtable by the output unit 110, and may output the data in at least one format from among a voice signal and a UI screen.

Further, based on the control command for outputting a system response by using data which is pre-stored in the display apparatus 100, the controller 150 may search for data which matches the control command from data which is pre-stored in the display apparatus 100, and may process the searched data in at least one format from among a voice signal and a UI screen and may output the data. To achieve this, the display apparatus 100 may store a UI screen for providing the system response and relevant data.

For example, the display apparatus 100 may store data which relates to a complete sentence format, such as, for example, “This function is not supported”.

Further, the display apparatus 100 may store some of the data which constitutes a system response, such as, for example, data relating to “The broadcast time of <broadcast program name> which you inquired about is <broadcast time>”. In this case, information for completing the system response may be received from the second server 300. For example, the controller 150 may complete the system response by using a broadcast program name or a channel number received from the second server 300, and then may output the system response such as, for example, “The broadcast time of ∘∘∘ (broadcast program name) which you inquired about is ∘ o'clock” in at least one format from among a voice signal and a UI screen.

When a user's utterance intention relates to at least one of a performance of a function of the display apparatus 100 and a search for a content, the controller 150 may output an additional question which relates to the at least one of the performance of the function and the search for the content which corresponds to the user's utterance intention as a system response. In this case, the controller 150 may use response information received from the second server 300.

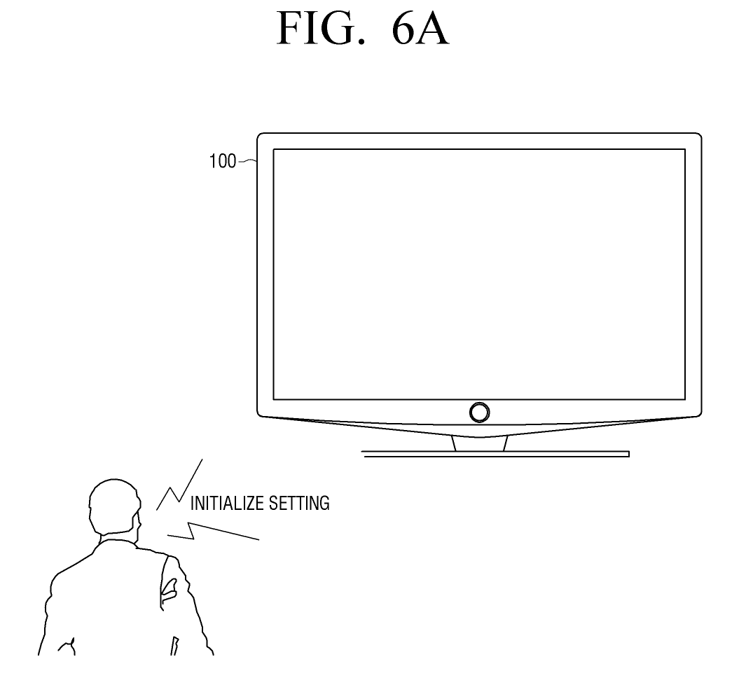

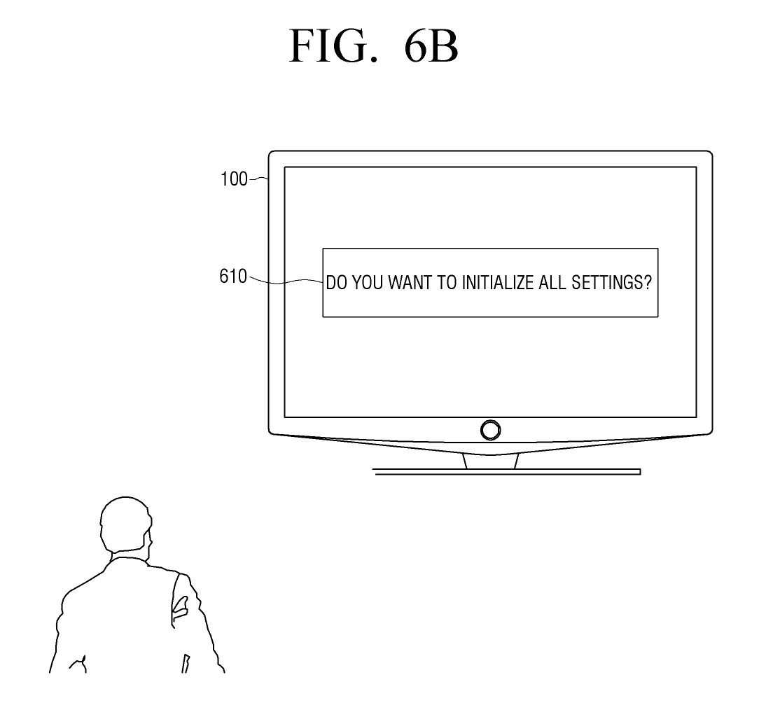

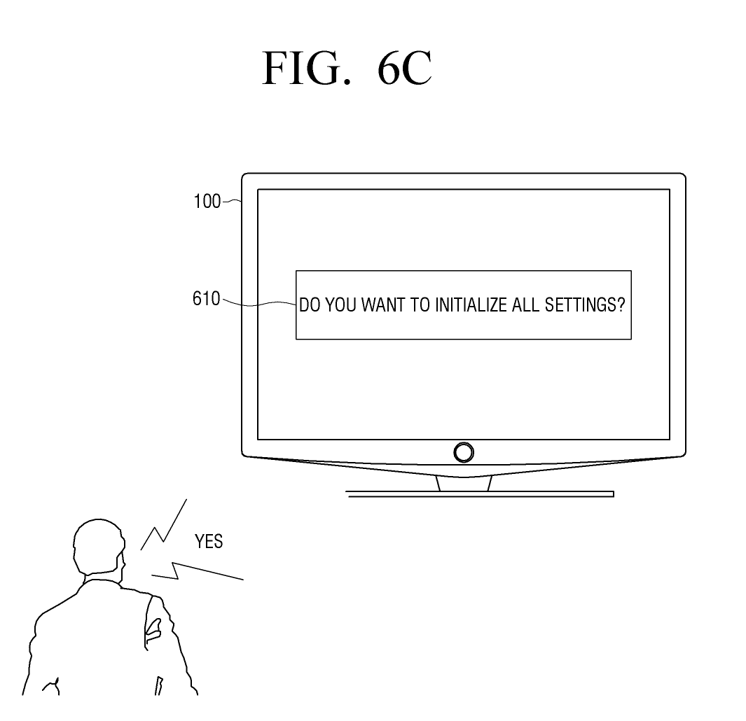

This will be described in detail below with reference to FIGS. 6A, 6B, 6C, 7A, 7B, 7C, 7D, 8A, 8B, 8C, 8D, 9A, 9B, 9C, and 9D.

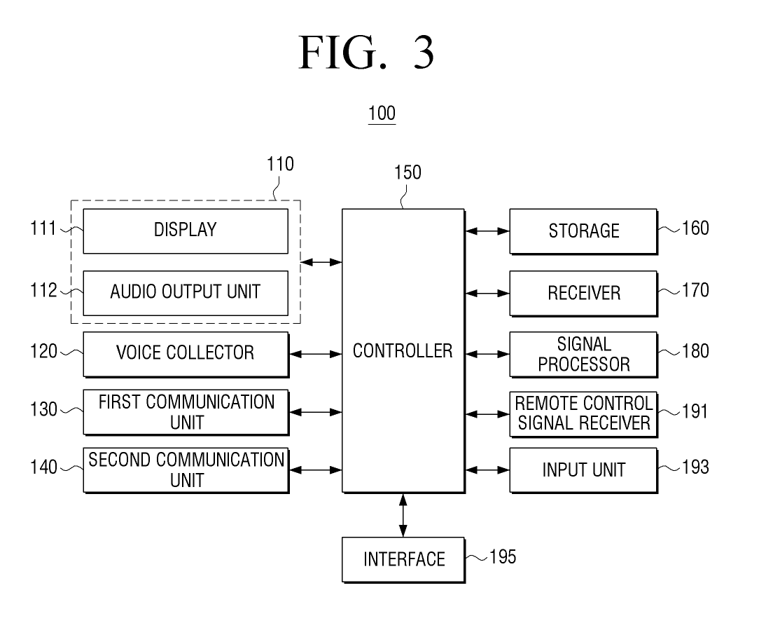

FIG. 3 is a block diagram which illustrates a detailed configuration of the display apparatus shown in FIG. 2. Referring to FIG. 3, the display apparatus 100 may further include a storage 160, a receiver 170, a signal processor 180, a remote control signal receiver 191, an input unit 193, and an interface 195, in addition to the elements shown in FIG. 2. These elements may be controlled by the controller 150. The same elements as those of FIG. 2 have the same functions and thus a redundant description is omitted.

The storage 160 is a storage medium that stores any one or more of various programs which may be necessary for operating the display apparatus 100, and may be implemented by using a memory and a hard disk driver (HDD). For example, the storage 160 may include a ROM for storing a program for performing an operation, and a RAM for temporarily storing data which results from the performance of the operation. The storage 160 may further include an electronically erasable and programmable ROM (EEPROM) for storing various reference data.

The receiver 170 receives various contents. Specifically, the receiver 170 may receive the contents from a broadcasting station which transmits a broadcast program via a broadcast network, or from a web server which transmits a content file by using the Internet.

The receiver 170 may include a tuner (not shown), a demodulator (not shown), and an equalizer in case that a content is received from a broadcasting station. Conversely, the receiver 170 may be implemented by using a network interface card in case that a content is received from a source such as, for example, a web server.

As described above, the receiver 170 may be implemented in any one or more of various forms, according to exemplary embodiments.

The signal processor 180 performs signal processing functions with respect to the content received via at least one of the receiver 170 and the interface 195 such that the content is output via the output unit 110.

Specifically, the signal processor 180 may convert the content into a format which is outputtable via a display 111 by performing at least one signal processing function such as decoding, scaling, and frame conversion with respect to an image which constitute the content. Further, the signal processor 180 may convert the content into a format which is outputtable via an audio output unit 122 by performing at least one signal processing function such as decoding with respect to audio data which constitutes the content.

The remote control signal receiver 191 receives a remote control signal which is input via an external remote controller. The controller 150 may perform any one or more of various functions based on the remote control signal which is received by the remote control signal receiver 191. For example, the controller 150 may perform functions such as power on/off, changing a channel, and controlling a volume based on the control signal which is received by the remote control signal receiver 191.

The input unit 193 receives various user commands. The controller 150 may perform a function which corresponds to a user command which is input to the input unit 193. For example, the controller 150 may perform a function such as power on/off, changing a channel, and controlling a volume based on a user command which is input to the input unit 193.

To achieve this, the input unit 193 may be implemented by using an input panel. The input panel may be at least one of a touch pad, a key pad which is equipped with various function keys, number keys, special keys and character keys, and a touch screen.

The interface 195 communicates with an external apparatus (not shown). The external apparatus (not shown) may be implemented by using any one or more of various types of electronic apparatuses and may transmit a content to the display apparatus 100.

For example, if the display apparatus 100 is implemented by using a TV, the external apparatus (not shown) may be implemented by using any one or more of various types of electronic apparatuses which are connected to the display apparatus 100 and perform their respective functions, such as a set-top box, a sound apparatus, a game machine, a DVD player, and a Blu-ray disk player.

For example, the interface 195 may communicate with the external apparatus (not shown) by using a wired communication method, such as, for example, HDMI or USB, or a wireless communication method, such as, for example, Bluetooth or Zigbee. To achieve this, the interface 195 may include a chip and/or an input port which corresponds to each communication method. For example, the interface 195 may include an HDMI port in case that the interface 195 communicates with the external apparatus (not shown) in the HDMI communication method.

The controller 150 may store user preference information in the storage 160. The user preference information may include information which relates to a broadcast program that the user has frequently viewed.

Specifically, the controller 150 may determine a broadcast program that is provided on a channel which is tuned via the receiver 170 based on electronic program guide (EPG) information every time that a power on command or a channel change command is received, and may store information which relates to at least one of a time at which the power on command and the channel change command is received, a title, a genre, a channel number, and a channel name of the determined broadcast program in the storage 160.

The controller 150 may analyze the stored information and may determine a content that the user has viewed more than a predetermined number of times as a broadcast program that the user has frequently viewed. The controller 150 may store information which relates to the broadcast program that the user has frequently viewed in the storage 160, and/or may control the second communication unit 140 to transmit the information to the second server 300.

Although various elements included in the display apparatus 100 are illustrated in FIG. 3, the display apparatus 100 does not necessarily include all of the elements, and is not limited to these elements. In particular, some of the elements may be omitted or a new element may be added based on a kind of the display apparatus 100, or the elements may be replaced with other elements.

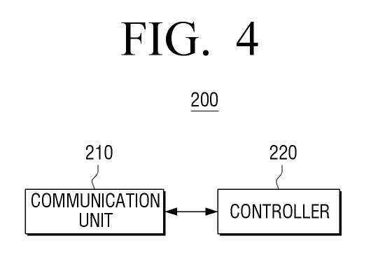

FIG. 4 is a block diagram which illustrates the first server of FIG. 1. As shown in FIG. 4, the first server 200 includes a communication unit 210 and a controller 220.

The communication unit 210 communicates with the display apparatus 100. Specifically, the communication unit 210 may receive a signal which relates to a user's voice from the display apparatus 100 and may transmit text information which corresponds to the user's voice to the display apparatus 100. To achieve this, the communication unit 210 may include any one or more of various communication modules.

The controller 220 controls an overall operation of the first server 200. In particular, when a signal which relates to a user's voice is received from the display apparatus 100, the controller 220 may generate text information which corresponds to the user's voice and may control the communication unit 210 to transmit the text information to the display apparatus 100.

Specifically, the controller 220 may generate text information which corresponds to a user's voice by using a speech-to-text (STT) engine. The STT engine is a module for converting a voice signal into text and may convert a voice signal into text by using any one or more of various STT algorithms which are disclosed in the related art.

For example, the controller 220 determines a voice section by detecting a beginning and an end of a voice uttered by the user from a received signal which relates to the user's voice. Specifically, the controller 220 calculates energy of a received voice signal, classifies an energy level of the voice signal based on the calculated energy, and detects the voice section by using dynamic programming. The controller 220 may generate phoneme data by detecting a phoneme, which is the smallest unit of voice, from the detected voice section based on an acoustic model, and may convert the signal which relates to the user's voice into text by applying a hidden Markov model (HMM) to the generated phoneme data.

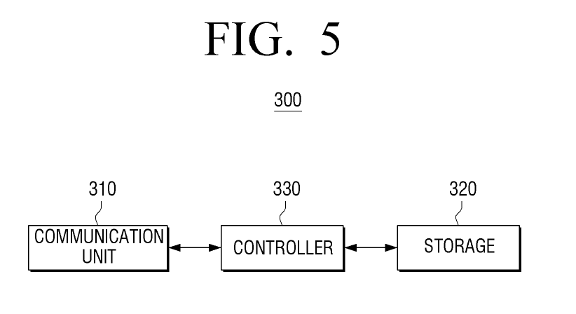

FIG. 5 is a block diagram which illustrates the second server of FIG. 1. As shown in FIG. 5, the second server 300 includes a communication unit 310, a storage 320, and a controller 330.

The communication unit 310 communicates with the display apparatus 100. Specifically, the communication unit 310 may receive text information from the display apparatus 100 and may transmit response information which corresponds to the text information to the display apparatus 100. To achieve this, the communication unit 310 may include any one or more of various communication modules.

The storage 320 stores a variety of information for generating response information which corresponds to the text information received from the display apparatus 100.

Specifically, the storage 320 stores a dialogue pattern based on a service domain. The service domain may be divided, for example, into “broadcast”, “video on demand (VOD)”, “apparatus control”, “application management”, and “information provision (weather, stock or news)” based on a subject of a voice uttered by the user. However, this is merely an example and the service domain may be divided by various subjects other than the above-described subjects. The above-described subjects may be integrated. For example, the broadcast service domain which relates to broadcast contents and the apparatus control domain may constitute a single domain.

More specifically, the storage 320 may include a corpus database for each service domain. The corpus database may be implemented by storing example sentences and responses thereto.

In particular, the storage 320 may store a plurality of example sentences for each service domain and a response to each of the example sentences. Further, the storage 320 may tag each example sentence with information which relates to interpreting the example sentence and a response which corresponds to the example sentence, and may store the tagged example sentences.

For example, it is assumed that an example sentence “When is ∘∘∘ (broadcast program name) aired?” is stored for the broadcast service domain.

In this case, the storage 320 may tag information which relates to interpreting the example sentence “When is ∘∘∘ (broadcast program name) aired?” on the corresponding example sentence, and may store the example sentence. Specifically, the storage 320 may tag the example sentence “When is ∘∘∘ (broadcast program name) aired?” with information indicating that “∘∘∘ (broadcast program name)” indicates a broadcast program name, information indicating that “when” indicates an inquiry about a broadcast time, and information indicating that “?” indicates that the example sentence is a question, and may store the tagged example sentence. Further, the storage 320 may tag the example sentence with information indicating that a broadcast program-related word is required in the middle of the sentence of a format such as, for example, “When is˜aired?”, and may store the tagged example sentence. The broadcast program-related word may include at least one of a broadcast program name, a cast, and a director.

The storage 320 may tag a response to “When is ∘∘∘ (broadcast program name) aired?” on the corresponding example sentence, and may store the tagged example sentence. Specifically, the storage 320 may tag “The broadcast time of <broadcast program name> which you inquired about is <a broadcast time>” on the example sentence as a response to “When is ∘∘∘ (broadcast program name) aired?”, and may store the tagged example sentence.

As another example, it is assumed that an example sentence “Please tune in to number ∘ (channel number)” is stored for the apparatus control service domain.

In this case, the storage 320 may tag information which relates to interpreting the example sentence “Please tune in to number ∘ (channel number)” on the corresponding example sentence, and may store the tagged example sentence. Specifically, the storage 320 may tag the example sentence “Please tune in to number ∘ (channel number)” with information indicating that “number ∘ (channel number)” indicates a channel number, information indicating that “tune in to” indicates a channel tuning command, and information indicating that “Please” indicates that the type of the example sentence is a request sentence, and may store the tagged example sentence. Further, the storage 320 may tag the example sentence with information indicating that a broadcast program-related word is required after the example sentence having a format such as, for example, “Please tune in to˜”, and may store the tagged example sentence. The broadcast program-related word may be at least one of a channel number, a channel name, a broadcast program name, a cast, and a director.

As still another example, the storage 320 may store example sentences such as “Yes”, “OK”, “No”, and “No way” for each service domain. In this case, the storage 320 may tag each example sentence with information which relates to interpreting each example sentence and may store the tagged example sentence.

Specifically, the storage 320 may tag the example sentences with information indicating that “Yes” and “OK” are affirmative sentences and “No” and “No way” are negative sentences, and may store the tagged example sentences.

Further, the storage 320 may tag a control command for controlling the display apparatus 100 on each example sentence, and may store the tagged example sentence. In particular, the storage 320 may tag an example sentence corresponding to a user's voice for controlling the display apparatus 100 with a control command for controlling the display apparatus 100, and may store the tagged example sentence. For example, the storage 320 may tag the example sentence “Please tune in to number ∘ (channel number)” with a control command for changing a channel of the display apparatus 100 to number ∘, and may store the tagged example sentence. The control command disclosed herein may be a system command of a script format.

A response to an example sentence may include an additional question. In this case, the storage 320 may tag every additional question with a meaning of the additional question and may store the tagged additional question, and may tag the additional question with a control command for controlling the display apparatus 100 and may store the tagged additional question.

For example, it is assumed that an example sentence “Initializing setting” is stored for the apparatus control domain.

In this case, the storage 320 may tag the example sentence with information which relates to interpreting the example sentence “Initialize setting”, and may store the tagged example sentence. Specifically, the storage 320 may tag the example sentence “Initialize setting” with information indicating that “setting” indicates a setting state of the display apparatus 100, “Initialize” is a request which relates to initializing the setting state of the display apparatus 100, and the type of the example sentence is a request sentence, and may store the tagged example sentence.

Further, the storage 320 may tag the example sentence “Initialize setting” with an additional question “Do you want to initialize all settings?”, and may store the tagged example sentence. In addition, the storage 320 may store information indicating that the meaning of “Do you want to initialize all settings?” is to inquire about whether to initialize all setting states of the display apparatus 100, and may tag the example sentence with a control command for initializing all setting states of the display apparatus 100.

As another example, it is assumed that an example sentence “Please turn up the volume appropriately” is stored for the apparatus control domain.

In this case, the storage 320 may tag the example sentence with information which relates to interpreting the example sentence “Please turn up the volume appropriately”, and may store the tagged example sentence. Specifically, the storage 320 may tag the example sentence “Please turn up the volume appropriately” with information indicating that “volume” indicates a volume of the display apparatus 100, information indicating that “turn up” and “appropriately” indicate a request to increase the volume to a predetermined volume level (for example, 10), and information indicating that “Please” indicates that the type of the example sentence is a request sentence, and may store the tagged example sentence.

The storage 320 may tag the example sentence “Please turn up the volume appropriately” with a control command for increasing the volume of the display apparatus 100 to a predetermined volume level (for example, 10), and may store the tagged example sentence.

The storage 320 may tag the example sentence “Please turn up the volume appropriately” with an additional question such as, for example, “The volume has been adjusted to 10, is it OK?”, and may store the tagged example sentence. The storage 320 may tag the additional question with a meaning of the question “The volume has been adjusted to 10, is it OK?”, and may store the tagged additional question. Specifically, the storage 320 may store information indicating that the meaning of the question “The volume has been adjusted to 10, it is OK?” is to inquire about whether to agree with the volume of the display apparatus 100 having been increased to 10.

As described above, the storage 320 may store the example sentence, the response, and the additional question. In this case, the storage 320 may tag the example sentence, the response and the additional question with information which relates to interpreting the example sentence and a meaning of the additional question, based on a meaning and an attribute of each word which constitutes the example sentence, the response, and the additional question.

Further, the storage 320 may store any one or more of various example sentences, various responses to the example sentences, and various additional questions which relate to the example sentences in connection with the above-described method. In this case, the storage 320 may tag the additional question with a control command for controlling the display apparatus 100, and may store the tagged additional question.

For example, the storage 320 may store an example sentence such as, for example, “I will quit watching TV (a name of the display apparatus 100)” for the apparatus control domain, and may tag this example sentence with information which relates to interpreting the corresponding example sentence and an additional question such as, for example, “Do you want to turn off the power?” and may store the tagged example sentence. At this time, the storage 320 may store information indicating that the meaning of the additional question “Do you want to turn off the power?” is to inquire about whether to turn off the power of the display apparatus 100, and may store a control command for turning off the power of the display apparatus 100.

For another example, the storage 320 may store an example sentence such as, for example, “I'd like to watch TV (a name of the display apparatus 100) until ∘ o'clock” for the apparatus control domain, and may tag this example sentence with information which relates to interpreting the corresponding example sentence and an additional question such as, for example, “Would you like to quit watching TV at ∘ o'clock?” and may store the tagged example sentence. At this time, the storage 320 may store information indicating that the meaning of “Would you like to quit watching TV at ∘ o'clock? relates to an inquiry about whether to turn off the display apparatus at ∘ o'clock, and may store a control command for turning off the power of the display apparatus 100.

As still another example, the storage 320 may store an example sentence such as, for example, “Please set an alarm for ∘ o'clock” for the apparatus control domain, and may tag this example sentence with information which relates to interpreting the corresponding example sentence and an additional question such as, for example, “You should set a current time first. Would you like to set a current time?” and may store the tagged example sentence. In this case, the storage 320 may store information indicating that the meaning of “You should set a current time first. Would you like to set a current time?” is to inquire about whether to set a time of the display apparatus, and may store a control command for displaying a time setting menu of the display apparatus 100.

As still another example, the storage 320 may store an example sentence such as, for example, “What time does ∘∘∘ (a broadcast program name) start on ∘∘ (date)?” for the broadcast service domain, and information which relates to interpreting the corresponding example sentence. In this case, the storage 320 may tag the corresponding example sentence with information indicating that a broadcast date-related word (for example, now or tomorrow) is required after the example sentence having a format such as, for example, “What time does ∘∘∘ (a broadcast program name) start on ˜?”, or is omitted, and may store the tagged example sentence.

In this case, the storage 320 may tag the example sentence “What time does ∘∘∘ (a broadcast program name) start on ∘∘ (date)?” with various additional questions.

First, the storage 320 may tag the corresponding example sentence with an additional question such as, for example, “It starts at ∘ (broadcast time) o'clock. Do you want to set an alarm?”, and may store the tagged example sentence. In this case, the storage 320 may store information indicating that the meaning of “It starts at ∘ (broadcast time) o'clock. Do you want to set an alarm?” is to inquire about whether to set an alarm of ∘∘∘ (broadcast program name), and may store a control command for setting an alarm of the display apparatus 100 for ∘ o'clock.

In this case, the storage 320 may tag the additional question “It starts at ∘ (broadcast time) o'clock. Do you want to set an alarm?” with another additional question such as, for example, “Do you want to schedule recording?”, and may store the tagged sentence. In this case, the storage 320 may store information indicating that the meaning of “Do you want to schedule recording” is to inquire whether to schedule a recording of ∘∘∘ (broadcast program name), and may store a control command for controlling the display apparatus 100 to schedule recording of ∘∘∘ (broadcast program name).

Secondly, the storage 320 may tag the corresponding example sentence with an additional question such as, for example, “∘∘∘ is not aired today. Would you like me to find out when it is aired?”, and may store the tagged example sentence. In this case, the storage 320 may store information indicating that the meaning of “∘∘∘ is not aired today. Would you like me to find out when it is aired?” is to inquire about whether to search for a broadcast time of ∘∘∘ (broadcast program name). In this case, the storage 320 may tag the example sentence with a response such as, for example, “The broadcast time of ∘∘∘ (broadcast program name) is <broadcast time>” in response to a signal which relates to a user's voice which is received in response to the additional question, and may store the tagged example sentence.

Thirdly, the storage 320 may tag the corresponding example sentence with an additional question such as, for example, “∘∘∘ is not aired today. Would you like me to find another broadcast program?”, and may store the tagged example sentence. In this case, the storage 320 may store information indicating that the meaning of “∘∘∘ is not aired today. Would you like me to find another broadcast program?” is to inquire about whether to search for a broadcast time of another program of the same genre as that of ∘∘∘ (broadcast program name). In this case, the storage 320 may tag the corresponding example sentence with a response such as, for example, “<broadcast program name> will be aired at <broadcast time>” as a response to a signal which relates to a user's voice which is received in response to the additional question.

Fourthly, the storage 320 may tag the corresponding example sentence with an additional question such as, for example, “It already started ∘∘ (hours) before. Do you want to change the channel?”, and may store the tagged example sentence. In this case, the storage 320 may store information indicating that the meaning of “It already started ∘∘ (hours) before. Do you want to change the channel?” is to inquire about whether to change a channel to a channel providing ∘∘∘ (broadcast program name), and may store a control command for controlling the display apparatus 100 to change a channel to a channel providing ∘∘∘ (broadcast program name).

As described above, the storage 320 may tag one example sentence with the plurality of additional questions, and may store the tagged example sentence.

As still another example, the storage 320 may store an example sentence such as, for example, “From what age are children allowed to watch ∘∘∘ (broadcast program name)?” for the apparatus control domain, and may tag this example sentence with information which relates to interpreting the corresponding example sentence and an additional question “Persons aged ∘ (age) or above are allowed to watch it. Do you want to watch it?” and may store the tagged example sentence. In this case, the storage 320 may store information indicating that the meaning of “Persons aged ∘ (age) or over are allowed to watch it. Do you want to watch it?” is to inquire about whether to change a channel to a channel providing ∘∘∘ (broadcast program name), and may store a control command for controlling the display apparatus 100 to change a channel to a channel providing ∘∘∘ (broadcast program name).

As still another example, the storage 320 may store an example sentence such as, for example, “Who is the director of ∘∘∘ (broadcast program name)?”, and may tag this example sentence with information which relates to interpreting the example sentence and an additional question such as, for example, “The director is ∘∘∘ (director's name). Would you like me to find other works directed by ∘∘∘?” and may store the tagged example sentence. In this case, the storage 320 may store information indicating that the meaning of “The director is ∘∘∘ (director's name). Would you like me to find other works directed by ∘∘∘?” is to inquire about whether to search for a broadcast program directed by ∘∘∘ (director's name). In addition, the storage 320 may tag the example sentence with a response “<broadcast program name>” as a response to a signal which relates to a user's voice which is received in response to the additional question.

As still another example, the storage 320 may store an example sentence such as, for example, “Please let me know when ∘∘∘ (broadcast program name) starts” for the broadcast service domain, and may tag this example sentence with information which relates to interpreting the example sentence and an additional question such as, for example, “∘∘∘ (broadcast program name) starts now. Do you want to change the channel?” and may store the tagged example sentence. In this case, the storage 320 may store information indicating that the meaning of “∘∘∘ (broadcast program name) starts now. Do you want to change the channel?” is to inquire about whether to change a channel to a channel providing ∘∘∘ (broadcast program name), and may store a control command for controlling the display apparatus to change a channel to a channel providing ∘∘∘ (broadcast program name).

As still another example, the storage 320 may store an example sentence such as, for example, “Please tune in to one of my favorite programs on ∘∘∘ (day of the week)” for the broadcast service domain, and may tag this example sentence with information which relates to interpreting the example sentence and additional questions such as, for example, “∘∘∘ (broadcast program name) will be aired at ∘ (broadcast time). Do you want to set an alarm?”, and “∘∘∘ (broadcast program) is on air. Do you want to change the channel?”, and may store the tagged example sentence.

In this case, the storage 320 may store information indicating that the meaning of “∘∘∘ (broadcast program name) will be aired at ∘ (broadcast time). Do you want to set an alarm?” is to inquire about whether to set an alarm for ∘∘∘ (broadcast program name), and may store a control command for controlling the display apparatus 100 to set an alarm for ∘ o'clock. In addition, the storage 320 may store information indicating that the meaning of “∘∘∘ (broadcast program) is on air. Do you want to change the channel?” is to inquire about whether to change a channel to a channel providing ∘∘∘ (broadcast program), and may store a control command for changing a channel of the display apparatus 100 to a channel providing ∘∘∘ (broadcast program).

As still another example, the storage 320 may store an example sentence such as, for example, “Is ∘∘ (genre) on ∘∘ (channel name) now?” for the broadcast service domain, and may tag this example sentence with information which relates to interpreting the example sentence and an additional question such as, for example, “<broadcast program> is now on ∘∘ (channel name). Do you want to find ∘∘ (genre)?”. In this case, the storage 320 may store information indicating that the meaning of “<broadcast program> is now on ∘∘ (channel number). Do you want to find ∘∘ (genre)?” is to inquire about whether to search for a broadcast program of ∘∘ (genre).

As still another example, the storage 320 may store an example sentence such as, for example, “Please show me a list of recorded broadcast programs”, and may tag this example sentence with information which relates to interpreting the example sentence and an additional question such as, for example, “The recorded broadcast programs are as follows. Which one would you like to watch?”, and may store the tagged example sentence. In this case, the storage 320 may store information indicating that the meaning of “The recorded broadcast programs are as follows. Which one would you like to watch?” is to inquire about which one the user would like to watch from among the recorded broadcast programs, and may store a control command for outputting the ∘th broadcast program from the list.

As still another example, the storage 320 may store an example sentence such as, for example, “Why is ∘∘∘ (broadcast program name) so boring?” for the broadcast service domain, and may tag this example sentence with information which relates to interpreting the example sentence and an additional question such as, for example, “It may be boring because it is just the beginning. Do you want to change the channel?”, and may store the tagged example sentence. In this case, the storage 320 may store information indicating that the meaning of “It may be boring because it is just the beginning. Do you want to change the channel?” is to inquire about whether to change a channel, and may store a control command for controlling the display apparatus 100 to change a channel to ∘ (channel number).

As described above, the storage 320 may store any one or more of various example sentences, responses, and additional questions.

The controller 330 controls an overall operation of the second server 300. In particular, when text information which corresponds to a user's voice is received from the display apparatus 100, the controller 330 may generate response information which corresponds to the received text information and may control the communication unit 310 to transmit the generated response information to the display apparatus 100.

Specifically, the controller 330 analyzes the text information and determines an utterance intention which is included in the signal which relates to the user's voice, and generates response information which corresponds to the determined utterance intention and controls the communication unit 310 to transmit the response information to the display apparatus 100.

To achieve this, the controller 330 detects a corpus database which contains a dialogue pattern which matches the received text information, and may determine a service domain to which the signal which relates to the user's voice belongs.

Specifically, the controller 330 compares the received text information with an example sentence stored for each service domain, and determines a service domain to which the example sentence which matches the received text information belongs as a service domain to which the signal which relates to the user's voice belongs.

For example, when text such as, for example, “When is ∘∘∘ (broadcast program name) aired?”, “Please tune in to number ∘ (channel number)”, or “Please turn up the volume appropriately” is received from the display apparatus 100, the controller 320 determines that the signal which relates to the user's voice which is collected by the display apparatus 100 belongs to the broadcast service domain. However, this is merely an example. When text information which matches any of various example sentences stored in the storage 320 is received, the controller 320 may determine that the signal which relates to the user's voice belongs to the respective service domain in which the mapping example sentences exist.

If there is no example sentence which matches the received text information, the controller 330 may statistically determine a domain to which the signal which relates to the user's voice belongs.

For example, it is assumed that the display apparatus 100 collects a signal which relates to a user's voice and which includes information which relates to “Would you please tune in to number ∘ (channel number)?” and transmits text corresponding to the collected signal which relates to the user's voice to the second server 300. In this case, the controller 330 determines that the signal which relates to the user's voice is statistically similar to “Please tune in to number ∘” using a classification model such as hidden Markov model (HMM), condition random fields (CRF), and support vector machine (SVM), and determines that “Would you please tune in to number ∘ (channel number)?” belongs to the broadcast service domain. However, this is merely an example and the controller 330 may determine to which domain a signal which relates to a user's voice belongs by determining whether the information which is included in the signal which relates to the user's voice is statistically similar to any of various example sentences stored in the storage 320.

The controller 330 extracts a dialogue act, a main action, and a component slot (or an object name) from a signal which relates to a user's voice based on the service domain to which the signal which relates to the user's voice belongs.

The dialogue act is a classification reference relating to a type of sentence, and indicates which type of sentence is used in the user's voice from among a statement, a request, and a question.

The main action is meaningful information indicating an action that a corresponding utterance desires in a specific domain based on dialogues. For example, the main action in the broadcast service domain may include at least one of turning on/off a TV, finding a broadcast program, finding a broadcast program time, and scheduling recording of a broadcast program. As another example, the main action in the apparatus control domain may include at least one of turning on/off an apparatus, reproducing, and pausing.

The component slot is object information which relates to a specific domain appearing in utterance, in particular, additional information which relates to specifying a meaning of an action that a specific domain intends.

For example, the component slot in the broadcast service domain may include at least one of a genre, a broadcast program name, a broadcast time, a channel number, a channel name, a cast, and a producer, and the component slot in the apparatus control service domain may include at least one of a name of an external apparatus and a manufacturer.

The controller 330 determines an utterance intention included in the signal which relates to the user's voice by using the extracted dialogue act, the main action, and the component slot, and generates response information which corresponds to the determined utterance intention and may transmit the response information to the display apparatus 100.

The response information disclosed herein may include a control command for controlling the display apparatus 100 to perform a specific function. To achieve this, the controller 330 may control to transmit a control command which is tagged on an example sentence which has been determined to match the user's voice to the display apparatus 100. In addition, the controller 330 may generate a control command which corresponds to the determined utterance intention and may control to transmit the generated control command to the display apparatus 100.

The response information may include system response information which relates to a system response which is output from the display apparatus 100. To achieve this, the controller 330 may extract a response and an additional question which relates to the determined utterance intention from the storage 320, may convert the extracted response and additional question into text, and may transmit the text to the display apparatus 100. In particular, the controller 330 may extract the response and the additional question which are tagged on the example sentence which matches the user's voice, may convert the extracted response and additional question into text, and may transmit the text to the display apparatus 100.

In this case, the controller 330 may control to transmit a control command for controlling the display apparatus 100 to output a system response to the display apparatus 100.

Hereinafter, a method for generating response information which corresponds to a user's voice, which method is executable by the controller 330, will be described in detail.

First, the controller 330 extracts a dialogue act, a main action, and a component slot from a signal which relates to a user's voice, using information which is tagged on an example sentence which matches the user's voice or an example sentence which is determined to be statistically similar to the user's voice, generates response information which corresponds to the user's voice, and transmits the response information to the display apparatus 100.

For example, it is assumed that text “When is ∘∘∘ (broadcast program name) aired?” is received from the display apparatus 100.

In this case, the controller 330 determines that the received text belongs to the broadcast service domain, extracts a dialogue act, a main action, and a component slot from the signal which relates to the user's voice, using information which is tagged on the example sentence “When is ∘∘∘ (broadcast program name) aired?” which matches the received text in the broadcast service domain, and generates corresponding response information.

In particular, as information which relates to interpreting the example sentence “When is ∘∘∘ (broadcast program name) aired?” which is stored in the broadcast service domain, information indicating that “∘∘∘ (broadcast program name)” indicates a broadcast program, “When” indicates an inquiry about a broadcast time, and “?” indicates that the type of the example sentence is a question may be tagged on the example sentence.

Accordingly, with reference to the information tagged on the example sentence, the controller 330 may determine that the dialogue act of the text which is received from the display apparatus 100, “When is ∘∘∘ (broadcast program name) aired?” is a question, the main action is inquiring about a broadcast time, and the component slot is ∘∘∘ (broadcast program name). Accordingly, the controller 330 may determine that the utterance intention of the user relates to inquiring about the broadcast time of ∘∘∘.

Further, the controller 330 may search for a response which is tagged on the example sentence stored in the broadcast service domain, “When is ∘∘∘ (broadcast program name) aired?” from the storage 320, and may generate response information by using the tagged response.

In particular, the controller 330 may search for a response such as, for example, “The broadcast time of <broadcast program name> which you inquired about is <broadcast time>” which is tagged on the example sentence stored in the broadcast service domain, “When is ∘∘∘ (broadcast program name) aired?” as a response to the user's voice.

In this case, the controller 330 fills in the blanks which are included in the searched response and generates a complete sentence.

For example, the controller 330 may enter “∘∘∘ (broadcast program name)” in the blank <broadcast program name> in the response “The broadcast time of <broadcast program name> which you inquired about is <broadcast time>”. The controller 330 may search for a broadcast time of “∘∘∘ (broadcast program name)” from EPG information and may enter the searched broadcast time in another blank <broadcast time>. Accordingly, the controller 330 may generate response information by expressing the complete sentence “The broadcast time of ∘∘∘ (broadcast program name) which you inquired about is ∘ (broadcast time) o'clock on Saturday” in a text format, and may transmit the response information to the display apparatus 100.

Accordingly, the display apparatus 100 may output “The broadcast time of ∘∘∘ (broadcast program name) which you inquired about is 7 o'clock on Saturday.” in at least one format from among a voice signal and a UI screen based on the response information received from the second server 300.

As another example, it is assumed that text “Please tune in to number ∘ (channel number)” is received from the display apparatus 100.

In this case, the controller 330 may determine that the received text belongs to the broadcast service domain, may extract a dialogue act, a main action, and a component slot from the signal which relates to the user's voice by using information which is tagged on the example sentence which matches the received text in the broadcast service domain “Please tune in to number ∘ (channel number)”, and may generate corresponding response information.

In particular, as information which relates to interpreting the example sentence stored in the broadcast service domain “Please tune in to number ∘ (channel number)”, information indicating that “number ∘ (channel number)” indicates a channel number, “tune in to” indicates a broadcast tuning command, and “Please” indicates that the type of the example sentence is a request is tagged on the example sentence. Accordingly, with reference to this information, the controller 330 may determine that the dialogue act of the text received from the display apparatus 100 “Please tune in to number ∘ (channel number)” is a request, the main action is the broadcast tuning command, and the component slot is number ∘ (channel number). Accordingly, the controller 330 may determine that the utterance intention of the user relates to a request to tune in to number ∘.

Further, the controller 330 may search for a control command which is tagged on the example sentence stored in the broadcast service domain “Please tune in to number ∘ (channel number)” from the storage 320, and may control to transmit the searched control command to the display apparatus 100. In particular, the controller 330 may transmit the control command for changing the channel of the display apparatus 100 to number ∘ to the display apparatus 100.

Accordingly, the display apparatus 100 may change the channel to number ∘ based on the response information received from the second server 300.

Although the controller 330 generates a control command for executing a function of the display apparatus 100 based on the control command tagged on the example sentence in the above example, this is merely an example.

In particular, the controller 330 may generate a control command based on the determined utterance intention, and may transmit the control command to the display apparatus 100. For example, when it is determined that the utterance intention of the user relates to a request to tune in to number ∘, the controller 330 may generate a control command for changing a channel to number ∘ and may transmit the control command to the display apparatus 100.

Although the controller 330 transmits the system response information which relates to outputting a system response on the display apparatus in the above example, this is merely an example.

In particular, if the display apparatus 100 pre-stores data which constitutes a system response, the controller 330 may transmit a control command for outputting the corresponding data as a system response to the display apparatus 100. In addition, if the display apparatus 100 pre-stores some of the data which constitutes the system response, the controller 330 may transmit only information which relates to outputting a complete system response to the display apparatus 100.

For example, if the display apparatus 100 pre-stores a response such as, for example, “The broadcast time of <broadcast program name> which you inquired about is <broadcast time>”, the controller 330 may control to transmit information which relates to a broadcast program name and a broadcast time which the user inquired about to the display apparatus 100, so that the display apparatus 100 makes the stored response into a complete sentence. In this case, the controller 330 may transmit a separate control command for outputting the response pre-stored in the display apparatus 100 to the display apparatus 100.

Accordingly, the display apparatus 100 may enter the information which is received from the second server 30 in the pre-stored response and may output “The broadcast time of ∘∘∘ (broadcast program name) which you inquired about is ∘ o'clock on Saturday” as a system response.

Although the controller 330 extracts the dialogue act, the main action, and the component slot by using the information tagged on the example sentence in the above exemplary embodiment, this is merely an example. In particular, the controller 330 may extract the dialogue act and the main action from the signal which relates to the user's voice by using a maximum entropy classifier (MaxEnt), and may extract the component slot by using a conditional random field (CRF).

However, this should not be considered as limiting. The controller 330 may extract the dialogue act, the main action, and the component slot from the signal which relates to the user's voice by using any one or more of various already-known methods.

If there is an additional question which corresponds to a user's voice based on a determined utterance intention when response information which corresponds to the determined utterance intention is generated, the controller 330 may generate the response information by using the additional question.

When text information which relates to a user's voice with respect to the additional question is received, the controller 330 may generate response information which corresponds to the received text information based on the additional question and may transmit the response information to the display apparatus 100.

In this case, when the controller 330 does not determine an utterance intention of the user which is included in the currently received signal which relates to the user's voice, the controller 330 may determine the utterance intention of the user which is included in the currently received signal which relates to the user's voice with reference to the previously received signal which relates to the user's voice. Specifically, when the controller 330 does not determine the utterance intention of the user which is included in the currently received signal which relates to the user's voice based on the service domain to which the previously received signal which relates to the user's voice belongs, the controller 330 may determine the utterance intention of the user which is included in the currently received signal which relates to the user's voice with reference to the previously received signal which relates to the user's voice.

Specifically, when the utterance intention of the user relates to a performance of a function of the display apparatus 100, the controller 330 may generate an additional question which relates to confirming whether to perform the function of the display apparatus 100, and may transmit response information which relates to outputting the additional question on the display apparatus 100 to the display apparatus 100. In this case, the controller 330 may determine an additional question which is tagged on an example sentence which matches the user's voice, may generate response information which relates to outputting the additional question, and may transmit the response information to the display apparatus 100.

For example, when it is determined that there is a risk in directly performing a function which corresponds to a user's voice such as, for example, “I will quit watching TV”, “I'd like to watch TV until 10 o'clock”, or “Initialize setting”, the controller 330 may generate response information which relates to outputting an additional question as a system response, and may transmit the response information to the display apparatus 100.

Hereinafter, it is assumed that text information corresponding to “I will quit watching TV”, “I'd like to watch TV until 10 o'clock”, or “Initialize setting” is received from the display apparatus 100.

In this case, using example sentences stored in the storage 320 and information which relates to interpreting the example sentences, the controller 330 may determine that the utterance intention of “I will quit watching TV” relates to a request to turn off the power the display apparatus 100, and that the utterance intention of “I'd like to watch TV until 10 o'clock” relates to a request to turn off the power of the display apparatus 100 at 10 o'clock. In addition, by using stored example sentences and information which relates to interpreting the example sentences, the controller 330 may determine that the utterance intention of “Initialize setting” relates to a request to initialize a setting state of the display apparatus 100.

However, because there is a risk in turning off the power of the display apparatus 100 or initializing the setting state of the display apparatus 100, the controller 330 may generate response information which relates to outputting an additional question prior to transmitting a control command for performing the corresponding function, and may transmit the response information.

Specifically, the controller 330 may express an additional question “Do you want to turn off the power?”, which is tagged on “I will quit watching the TV”, an additional question “Do you want to quit watching the TV at 10 o'clock?”, which is tagged on “I'd like to watch TV until 10 o'clock”, or an additional question “Do you want to initialize all settings?”, which is tagged on “Initialize setting”, in a text format, and may transmit the additional question to the display apparatus 100. Accordingly, the display apparatus 100 may output “Do you want to turn off the power?”, “Do you want to quit watching the TV at 10 o'clock?”, or “Do you want to initialize all setting?” as a voice signal based on the response information received from the second server 300, or may output a UI screen which includes “Do you want to turn off the power?”, “Do you want to quit watching the TV at 10 o'clock?”, or “Do you want to initialize all settings?”.

Subsequently, the controller 330 may transmit a control command for controlling the function of the display apparatus based on a signal which relates to a user's voice which is received in response to the additional question to the display apparatus 100. In this case, the controller 330 may determine an utterance intention of the received signal which relates to the user's voice based on the meaning of the additional question, and may transmit a control command which is tagged on the additional question to the display apparatus such that the function of the display apparatus 100 is controlled.

For example, when text information such as, for example, “Yes” is received in response to the additional question “Do you want to turn off the power?”, the controller 330 may determine that the utterance intention relates to a request to turn off the power of the display apparatus 100, and may transmit a control command for turning off the power of the display apparatus 100 to the display apparatus 100. Accordingly, the display apparatus 100 may turn off the power of the display apparatus 100 based on the response information received from the second server 300.

As another example, when text information such as, for example, “Yes” is received in response to the additional question “Do you want to quit watching the TV at 10 o'clock?”, the controller 330 may determine that the utterance intention relates to a request to turn off the power of the display apparatus 100 at 10 o'clock, and may transmit a control command for turning off the power of the display apparatus 100 at 10 o'clock to the display apparatus 100. Accordingly, the display apparatus 100 may turn off the power at 10 o'clock based on the response information received from the second server 300.

As still another example, when text information such as, for example, “Yes” is received in response to the additional question “Do you want to initialize all settings?”, the controller 330 may determine that the utterance intention relates to a request to initialize all setting states of the display apparatus 100, and may transmit a control command for initializing all setting states of the display apparatus 100 to the display apparatus 100. Accordingly, the display apparatus 100 may initialize all setting states based on the response information received from the second server 300.

When it is determined that the user arbitrarily quantifies ambiguous speech such as, for example, “Turn up the volume appropriately”, the controller 330 may generate response information which relates to outputting an additional question as a system response and may transmit the response information to the display apparatus 100.

Specifically, when text information which corresponds to “Turn up the volume appropriately” is received from the display apparatus 100, the controller 330 may determine that the utterance intention of “Turn up the volume appropriately” relates to a request to turn up the volume to a predetermined volume level (for example, 10), by using example sentences which are stored in the storage 320 and information which relates to interpreting the corresponding example sentences, and may transmit a control command for increasing the volume of the display apparatus 100 to a predetermined volume level (for example, 10) to the display apparatus 100. Accordingly, the display apparatus 100 may increase the volume to a predetermined volume level (for example, 10) based on response information received from the second server 300.

The controller 330 may express an additional question which relates to confirming whether the user wants to turn up the volume to a predetermined volume level, such as, for example, “The volume has been adjusted to 10. Is it ok?”, in a text format, and may transmit the additional question to the display apparatus 100. Subsequently, when text information such as, for example, “Yes” is received, the controller 330 may determine that the utterance intention relates to a confirmation that the adjusted volume level 10 is satisfactory.

Conversely, when the utterance intention of the user relates to a performance of a function of the display apparatus 100 which function requires a performance of a prior function prior to performing the function of the display apparatus 100, the controller 330 may generate an additional question which relates to the prior function and may transmit response information which relates to outputting the additional question on the display apparatus 100 to the display apparatus 100.

For example, when it is necessary to perform a prior function of setting a current time prior to setting an alarm in response to “Please set an alarm for ∘ o'clock (hour)”, the controller 330 may generate response information which relates to outputting an additional question as a system response and may transmit the response information to the display apparatus 100.

Specifically, when text information which corresponds to “Please set an alarm for ∘ o'clock (hour)” is received from the display apparatus 100, the controller 330 may determine that the utterance intention of “Please set an alarm for ∘ o'clock (hour)” relates to a request for the display apparatus 100 to set an alarm for ∘ o'clock (hour), using an example sentence which is stored in the storage 320 and information which relates to interpreting the corresponding sentence.

In this case, the controller 330 may determine that it is necessary for the display apparatus to set a current time prior to setting an alarm, and may express an additional question such as, for example, “You should set a current time first. Would you like to set a current time?” in a text format and may transmit the additional question to the display apparatus 100. Accordingly, the display apparatus 100 may output “You should set a current time first. Would you like to set a current time?” as a voice signal based on response information received from the second server 300, and may output a UI screen which includes “You should set a current time first. Would you like to set a current time?”

Subsequently, when text information such as, for example, “Yes” is received, the controller 330 may determine that the utterance intention relates to a request to set a time of the display apparatus 100, and may transmit a control command for displaying a time setting menu on the display apparatus 100 to the display apparatus 100. Accordingly, the display apparatus 200 may display the time setting menu based on response information which is received from the second server 300.

Conversely, when the utterance intention of the user relates to a search for a content, the controller 330 may generate an additional question that is anticipated based on a result of searching for the content and/or an additional question that relates to a potential result of the searching, and may transmit response information which relates to outputting the additional question on the display apparatus 100 to the display apparatus 100.

For example, when text information which corresponds to “What time does ∘∘∘ (broadcast program name) start?” is received from the display apparatus 100, the controller 330 may determine that the utterance intention of “What time does ∘∘∘ (broadcast program name) start?” relates to a request to search for a broadcast time of ∘∘∘(broadcast program name), by using an example sentence which is stored in the storage 320 and information which relates to interpreting the corresponding example sentence. In this case, the controller 330 may search for a broadcast time ∘ of ∘∘∘ (broadcast program name) with reference to EPG information, and may express an additional question such as, for example, “It starts at ∘ o'clock (broadcast time). Would you like to set an alarm?” in a text format and may transmit the additional question to the display apparatus 100.

Accordingly, the display apparatus 100 may output “It starts at ∘ o'clock (broadcast time). Would you like to set an alarm?” as a voice signal based on the response information received from the second server 300, or may output a UI screen which includes “It starts at ∘ o'clock (broadcast time). Would you like to set an alarm?”

Subsequently, when text information such as, for example, “Yes” is received, the controller 330 may determine that the utterance intention relates to a request to set an alarm of the display apparatus 100 for ∘ o'clock (broadcast time), and may transmit a control command for setting an alarm of the display apparatus 100 for ∘ o'clock to the display apparatus 100. Accordingly, the display apparatus 100 may set an alarm for ∘ o'clock based on the response information received from the second server 300.

However, when text information such as, for example, “No” is received, the controller 330 may determine that the utterance intention relates to a refusal to set an alarm of the display apparatus 100 for ∘ o'clock (broadcast time). In this case, the controller 330 may transmit response information which relates to outputting another additional question tagged on the additional question to the display apparatus 100. For example, the controller 330 may express another additional question such as, for example, “Is it necessary to schedule recording?”, which is tagged on the additional question “It starts at ∘ o'clock (broadcast time). Would you like to set an alarm?”, in a text format, and may transmit the another additional question to the display apparatus 100. Accordingly, the display apparatus 100 may output “Is it necessary to schedule recording?” as a voice signal based on the response information received from the second server 300, or may output a UI screen which includes “Is it necessary to schedule recording?”

Subsequently, when text information such as, for example, “Yes” is received, the controller 330 may determine that the utterance intention relates to a request to schedule a recording at ∘ o'clock (broadcast time), and may transmit a control command to schedule a recording of ∘∘∘ (broadcast program name) starting at ∘ o'clock (broadcast time) to the display apparatus 100. Accordingly, the display apparatus 100 may schedule a recording of ∘∘∘ (broadcast program name) starting at ∘ o'clock (broadcast time) based on the response information received from the second server 300.

As described above, when the utterance intention of the user relates to an inquiry about a broadcast time of a specific broadcast program and one specific broadcast program is searched accordingly, the controller 330 may generate additional questions which relate to setting an alarm and scheduling a recording and may transmit the additional questions to the display apparatus 100.

For another example, when text information such as, for example, “What time does ∘∘∘ (broadcast program) start today”? is received from the display apparatus 100, the controller 330 may determine that the utterance intention of “What time does ∘∘∘ (broadcast program name) start today?” relates to a request to search for a broadcast time of ∘∘∘ (broadcast program name) today, by using an example sentence which is stored in the storage 320 and information which relates to interpreting the corresponding example sentence. In this case, the controller 330 may check whether ∘∘∘ (broadcast program name) is aired today or not with reference to EPG information.

When it is determined that ∘∘∘ (broadcast program name) is not to be aired today as a result of checking, the controller 330 may express an additional question such as, for example, “∘∘∘ is not aired today. Would you like me to find out when it is aired?” in a text format, and may transmit the additional question to the display apparatus 100. Accordingly, the display apparatus 100 may output “∘∘∘ is not aired today. Would you like me to find out when it is aired?” as a voice signal based on the response information received from the second server 300, or may output a UI screen which includes “∘∘∘ is not aired today. Would you like me to find out when it is aired?”

Subsequently, when text information such as, for example, “Yes” is received, the controller 330 may determine that the utterance intention relates to a request to search for a broadcast time of ∘∘∘ (broadcast program name) at a different date, and may search for a broadcast time of ∘∘∘ (broadcast program name) with reference to EPG information. In addition, the controller 330 may express an additional question such as, for example, “The broadcast time of ∘∘∘ (broadcast program name) is ∘ o'clock (broadcast time) on ∘ day.” in a text format using the searched broadcast time, and may transmit the additional question to the display apparatus 100. Accordingly, the display apparatus 100 may output “The broadcast time of ∘∘∘ (broadcast program name) is ∘ o'clock (broadcast time) on ∘ day.” as a voice signal based on the response information received from the second server 300, or may output a UI screen which includes “The broadcast time of ∘∘∘ (broadcast program name) is ∘ o'clock (broadcast time) on ∘ day.”

Further, when it is determined that ∘∘∘ (broadcast program name) is not to be aired today, the controller 330 may express an additional question such as, for example, “∘∘∘ is not aired today. Would you like me to find another broadcast program?” in a text format, and may transmit the additional question to the display apparatus 100. Accordingly, the display apparatus 100 may output “∘∘∘ is not aired today. Would you like me to find another broadcast program? as a voice signal based on the response information received from the second server 300, or may output a UI screen which includes “∘∘∘ is not aired today. Would you like me to find another broadcast program?”

Subsequently, when text information such as, for example, “Yes” is received, the controller 330 may determine whether the utterance intention relates to a request to search for a broadcast program of the same genre as that of ∘∘∘ (broadcast program name), may search for a broadcast program of the same genre as that of ∘∘∘ (broadcast program name) with reference to EPG information, may express a response such as, for example, “ΔΔΔ will be aired at Δ o'clock on Δ day” in a text format and may transmit the response to the display apparatus 100. Accordingly, the display apparatus 100 may output “ΔΔΔ will be aired at Δ o'clock on Δ day” as a voice signal based on the response information received from the second server 300, or may output a UI screen which includes “ΔΔΔ will be aired at Δ o'clock on Δ day”.

As described above, when a search for a content relates to an inquiry about a broadcast time of a first specific content, the controller 330 may generate an additional question which relates to at least one of a search for a broadcast time of a first specific content and a search for a second specific content which is similar to the first specific content, and may transmit the additional question to the display apparatus 100. In particular, when the utterance intention of the user relates to an inquiry about a specific broadcast program at a designated specific date, the controller 330 may generate an additional question which relates to at least one of a search for a broadcast time of the specific broadcast program and a search for a broadcast program which is similar to the specific broadcast program, and may transmit the additional question to the display apparatus 100.

In this case, the controller 330 may generate the additional question which relates to the search for the broadcast time of the specific broadcast program first, and, when text information having a negative meaning is received from the display apparatus 100, the controller 330 may generate the additional question which relates to the search for the similar broadcast program and may transmit the additional question to the display apparatus 100.

For another example, when text information which corresponds to “What time does ∘∘∘ (broadcast program name) start?” is received from the display apparatus 100, the controller 330 may determine that the utterance intention of “What time does ∘∘∘ (broadcast program name) start?” relates to a request to search for a broadcast time of ∘∘∘ (broadcast program name), and may search for a broadcast time of ∘∘∘ (broadcast program name) with reference to EPG information. When it is determined that ∘∘∘ (broadcast program name) is on air as a result of searching, the controller 330 may convert an additional question such as, for example, “It started ∘∘ (hour) before. Do you want to change the channel?” into a text format, and may transmit this text to the display apparatus 100.

Accordingly, the display apparatus 100 may output “It started ∘∘ (hour) before. Do you want to change the channel?” as a voice signal based on the response information received from the second server 300, or may output a UI screen which includes “It started ∘∘ (hour) before. Do you want to change the channel?”

Subsequently, when text information such as, for example, “Yes” is received, the controller 330 may determine that the utterance intention relates to a request to change a current channel to a channel providing ∘∘∘ (broadcast program name), and may transmit a control command for changing a current channel to a channel providing ∘∘∘ (broadcast program name) to the display apparatus 100. Accordingly, the display apparatus 100 may change a current channel to a channel providing ∘∘∘ (broadcast program name) based on the response information received from the second server 300.

As described above, when a search for a content relates to an inquiry about a broadcast time of a specific content and the searched content is on air (i.e., being broadcasted), the controller 330 may generate an additional question which relates to an inquiry about whether to change a current channel to a channel providing the specific content, and may transmit the additional question to the display apparatus 100.

As still another example, when text information which corresponds to “From what age are children allowed to watch ∘∘∘ (broadcast program name)?” is received from the display apparatus 100, the controller 330 may determine that the utterance intention of “From what age are children allowed to watch ∘∘∘ (broadcast program name)?” relates to a request to search for a rating of ∘∘∘ (broadcast program name), by using an example sentence which is stored in the storage 320 and information which relates to interpreting the corresponding example sentence. In this case, the controller 330 may search for a rating of ∘∘∘ (broadcast program name) with reference to EPG information, may express an additional question such as, for example, “Persons aged ∘ (age) or above are allowed to watch the broadcast program. Do you want to watch it?” in a text format, and may transmit the additional question to the display apparatus 100.

Accordingly, the display apparatus 100 may output “Persons aged ∘ (age) or above are allowed to watch the broadcast program. Do you want to watch it?” as a voice signal based on the response information received from the server 300, or may output a UI screen which includes “Persons aged ∘ (age) or above are allowed to watch the broadcast program. Do you want to view it?”

Subsequently, when text information such as, for example, “Yes” is received, the controller 330 may determine that the utterance intention relates to a request to change a current channel to a channel providing ∘∘∘ (broadcast program name), and may transmit a control command for changing a channel to a channel providing ∘∘∘ (broadcast program name) to the display apparatus 100. Accordingly, the display apparatus 100 may change a channel to a channel providing ∘∘∘ (broadcast program name) based on the response information received from the second server 300.

As described above, when a search for a content relates to a rating of a specific content, the controller 330 may generate an additional question which relates to an inquiry about whether to change a channel to a channel providing the specific content, and may transmit the additional question to the display apparatus 100. In particular, if a rating of the specific content indicates that teenager under 19 cannot watch the specific content, the controller 330 may generate an additional question which relates to an inquiry as to whether to change a channel to a channel providing the specific content, and may transmit the additional question to the display apparatus 100.

As still another example, when text information which corresponds to “Who is the director of ∘∘∘ (broadcast program name)?” is received from the display apparatus 100, the controller 330 may determine that the utterance intention of “Who is the director of ∘∘∘ (broadcast program name)?” relates to a request to search for a director of ∘∘∘ (broadcast program name), by using an example sentence which is stored in the storage 320 and information which relates to interpreting the corresponding example sentence. In this case, the controller 330 may search for a director of ∘∘∘ (broadcast program name) with reference to EPG information, may express an additional question such as, for example, “The director of ∘∘∘ (broadcast program name) is ∘∘∘ (searched director's name). Would you like me to find other works directed by ∘∘∘?” in a text format, and may transmit the additional question to the display apparatus 100. Accordingly, the display apparatus 100 may output “The director of ∘∘∘ (broadcast program name) is ∘∘∘ (searched director's name). Would you like me to find other works directed by ∘∘∘?” as a voice signal based on the response information received from the second server 300, or may output a UI screen which includes “The director of ∘∘∘ (broadcast program name) is ∘∘∘ (searched director's name). Would you like me to find other works directed by ∘∘∘?”

Subsequently, when text information such as, for example, “Yes” is received, the controller 330 may determine that the utterance intention relates to a request to search for a broadcast program directed by ∘∘∘ (searched director's name), and may search for a broadcast program which is produced by ∘∘∘ (searched director's name) with reference to EPG information. In addition, the controller 330 may express a response such as, for example, “ΔΔΔ (searched broadcast program name)” in a text format and may transmit the response to the display apparatus 100. Accordingly, the display apparatus 100 may output “ΔΔΔ (searched broadcast program name)” as a voice signal based on the response information received from the second server 300, or may output a UI screen which includes “ΔΔΔ (searched broadcast program name)”.

As described above, when a search for a content relates to a search for a person related to a specific content, the controller 330 may generate an additional question which relates to an inquiry about whether to search for another content related to the person, and may transmit the additional question to the display apparatus 100. In this case, if one person is searched based on the utterance intention, the controller 330 may generate an additional question which relates to an inquiry about whether to search for another content related to the person and may transmit the additional question to the display apparatus 100.

As still another example, when text information which corresponds to “Please let me know when ∘∘∘ (broadcast program name) starts” is received from the display apparatus 100, the controller 330 may determine that the utterance intention of “Please let me know when ∘∘∘ (broadcast program name) starts” relates to a request to search for a broadcast time of ∘∘∘ (broadcast program name) and to set an alarm, by using an example sentence stored in the storage 320 and information which relates to interpreting the corresponding example sentence. In this case, the controller 330 may search for a broadcast time of ∘∘∘ (broadcast program name) with reference EPG information, may express an additional question such as, for example, “∘∘∘ (broadcast program name) starts. Do you want to change the channel?” in a text format when the broadcast time has come, and may transmit the additional question to the display apparatus 100. Accordingly, the display apparatus 100 may output “∘∘∘ (broadcast program name) starts. Do you want to change the channel?” as a voice signal based on the response information received from the second server 300, or may output a UI screen which includes “∘∘∘ (broadcast program name) starts. Do you want to change the channel?”

Subsequently, when text information such as, for example, “Yes” is received, the controller 330 may determine that the utterance intention relates to a request to change a channel to a channel providing ∘∘∘ (broadcast program name), and may transmit a control command for changing a channel to a channel providing ∘∘∘ (broadcast program name) to the display apparatus 100. Accordingly, the display apparatus 100 may change a channel to a channel providing ∘∘∘ (broadcast program name) based on the response information received from the second server 300.

As still another example, when text information which corresponds to “Please tune in to one of my favorite broadcast programs on ∘∘∘ (day)” is received from the display apparatus 100, the controller 330 may determine that the utterance intention relates to a request to search for a broadcast time of a broadcast program that the user frequently watched on ∘∘∘ (day), by using an example sentence which is stored in the storage 320 and information which relates to interpreting the corresponding example sentence. Conversely, information which relates to a broadcast program that the user has frequently watched (for example, a broadcast program name) may be pre-stored in the storage 320 or may be received from the display apparatus 100.

Accordingly, the controller 330 may search for a broadcast time of the broadcast program that the user has frequently watched with reference to EPG information, may convert an additional question such as, for example, “∘∘∘ (broadcast program name) will be aired at ∘ (broadcast time). Do you want to set an alarm?” into a text format, and may transmit the additional question to the display apparatus 100. Accordingly, the display apparatus 100 may output “∘∘∘ (broadcast program name) will be aired at ∘ (broadcast time). Do you want to set an alarm?” as a voice signal based on the response information received from the second server 300, or may output a UI screen which includes “∘∘∘ (broadcast program name) will be aired at ∘ (broadcast time). Do you want to set an alarm?”.

Subsequently, when text information such as, for example, “Yes” is received, the controller 330 may determine that the utterance intention relates to a request to set an alarm of ∘∘∘ (broadcast program name), and may transmit a control command for setting an alarm of ∘∘∘ (broadcast program name) to the display apparatus 100. Accordingly, the display apparatus 100 may set an alarm of ∘∘∘ (broadcast program name) based on the response information received from the second server 300.

Further, the controller 330 may search for the broadcast time of the broadcast program that the user has frequently watched with reference to EPG information, may convert an additional question such as, for example, “∘∘∘ (broadcast program name) is on air. Do you want to change the channel?” into a text format, and may transmit the additional question to the display apparatus 100. Accordingly, the display apparatus 100 may output “∘∘∘ (broadcast program name) is on air. Do you want to change the channel?” as a voice signal based on the response information received from the second server 300, and may output a UI screen which includes “∘∘∘ (broadcast program name) is on air. Do you want to change the channel?”

Subsequently, when text information such as, for example, “Yes” is received, the controller 330 may determine that the utterance intention relates to a request to change a channel to a channel providing ∘∘∘ (broadcast program name), and may transmit a control command for changing a channel to a channel providing ∘∘∘ (broadcast program name) to the display apparatus 100. Accordingly, the display apparatus 100 may change a channel to a channel providing ∘∘∘ (broadcast program name) based on the response information received from the second server 300.

As described above, when a search for a content relates to a search for a content that the user has frequently watched, the controller 330 may generate an additional question which relates to an inquiry about whether to set an alarm or change a channel and may transmit the additional question to the display apparatus 100. In this case, the controller 330 may generate an additional question which relates to setting an alarm when the broadcast time of the searched content has come within a predetermined time with respect to a current time, or may generate an additional question which relates to changing a channel when the content is on air.

As still another example, when text information which corresponds to “Is ∘∘ (genre) now on ∘∘ (channel name)?” is received from the display apparatus 100, the controller 330 may determine that the utterance intention of “Is ∘∘ (genre) now on ∘∘ (channel name)?” relates to an inquiry about whether a broadcast program of ∘∘ (genre) is aired on ∘∘ (channel number), by using an example sentence which is stored in the storage 320 and information which relates to interpreting the corresponding example sentence. In this case, the controller 330 may determine whether a broadcast program of ∘∘ (genre) is now aired on ∘∘ (channel number) with reference to EPG information.

When it is determined that a broadcast program of ∘∘ (genre) is not aired on ∘∘ (channel name) as a result of determining, the controller 330 may search for a broadcast program that is now aired on ∘∘ (channel name), may express an additional question such as, for example, “∘∘∘ (searched broadcast program name) is now aired on ∘∘ (channel number). Would you like me to find ∘∘ (genre)?” in a text format, and may transmit the additional question to the display apparatus 100. Accordingly, the display apparatus 100 may output “∘∘∘ (searched broadcast program name) is now aired on ∘∘ (channel number). Would you like me to find ∘∘ (genre)?” as a voice signal based on the response information received from the second server 300, or may output a UI screen which includes “∘∘∘ (searched broadcast program name) is now aired on ∘∘ (channel number). Would you like me to find ∘∘ (genre)?”.

Subsequently, when text information such as, for example, “Yes” is received, the controller 330 may determine that the utterance intention of the user relates to a request to search for a broadcast program of ∘∘ (genre), and may search for a broadcast program of ∘∘ (genre) with reference to EPG information. The controller 330 may express a response such as, for example, “ΔΔΔ (additionally searched broadcast program name)” in a text format, and may transmit the response to the display apparatus 100. Accordingly, the display apparatus 100 may output “ΔΔΔ (additionally searched broadcast program name)” as a voice signal based on the response information received from the second server 300, or may output a UI screen which includes “ΔΔΔ (additionally searched broadcast program name)”.

As described above, when the utterance intention of the user indicates a specific situation, in particular, is the utterance intention relates to a search for a specific content on a designated channel at a designated time, but a content which matches the utterance intention is not found as a result of the search, the controller 330 may generate an additional question which relates to conducting an additional search for another content and may transmit the additional question to the display apparatus 100.

As still another example, when text information which corresponds to “Please show me a list of recorded broadcasts” is received from the display apparatus 100, the controller 330 may determine that the utterance intention of “Please show me a list of recorded broadcasts” relates to a request to output a list of recorded broadcast programs by using an example sentence which is stored in the storage 320 and information which relates to interpreting the corresponding example sentence. The controller 330 may generate a control command for controlling the display apparatus 100 to output a list of recorded broadcast programs, and may express an additional question such as, for example, “The recorded broadcast programs are as follows. Which one would you like to watch?” in a text format and may transmit the additional question to the display apparatus 100. Accordingly, the display apparatus 100 may output “The recorded broadcast programs are as follows. Which one would you like to watch?” as a voice signal based on the response information received from the second server 300, or may output a UI screen which includes “The recorded broadcast programs are as follows. Which one would you like to watch?”. In addition, the display apparatus 100 may output the list of recorded broadcast programs.

Subsequently, when text information such as, for example, “third” is received, the controller 330 may determine that the utterance intention relates to a request to reproduce the third broadcast program in the list, and may transmit a control command for reproducing the third broadcast program in the list to the display apparatus 100. Accordingly, the display apparatus 100 may reproduce the third broadcast program in the list of recorded broadcast programs based on the response information received from the second server 300.

As still another example, when text information which corresponds to “Why is ∘∘∘ (broadcast program name) so boring?” is received from the display apparatus 100, the controller 330 may determine that the utterance intention of “Why is ∘∘∘ (broadcast program name) so boring?” relates to changing a channel to another broadcast program, by using an example sentence which is stored in the storage 320 and information which relates to interpreting the corresponding example sentence. In this case, the controller 330 may convert an additional question such as, for example, “It may be boring because it is just the beginning. Do you want to change the channel?” into a text form, and may transmit the additional question to the display apparatus 100. Accordingly, the display apparatus 100 may output “It may be boring because it is just the beginning. Do you want to change the channel?” as a voice signal based on the response information received from the second server 300, or may output a UI screen which includes “It may be boring because it is just the beginning. Do you want to change the channel?”

Subsequently, when text information which corresponds to “Please change the channel to number ∘ (channel number)” is received, the controller 330 may determine that the utterance intention relates to changing a channel to number ∘ (channel number), and may transmit a control command for changing a channel to number ∘ (channel number) to the display apparatus 100. Accordingly, the display apparatus 100 may change a channel to number ∘ (channel number) based on the response information received from the second server 300.

As described above, when the user clearly recognizes what broadcast program he or she is watching, the controller 330 may generate an additional question which relates to an inquiry about whether to watch another broadcast program, and may transmit the additional question to the display apparatus 100. In this case, if the broadcast program that the user is currently watching is not aired as much as a predetermined amount of time out of the total running time of the broadcast program, the controller 330 may generate the additional question described above and may transmit the additional question to the display apparatus 100.

As described above, the second server 300 may generate an additional question based on a determination of an utterance intention of a user and may transmit the additional question to the display apparatus 100, and the display apparatus 100 may output the additional question received from the second server 300 as a system response. The second server 300 may analyze an utterance intention which is included in the user's voice to the additional question, and may perform a function which corresponds to the utterance intention or may control the display apparatus 100 to perform a function which corresponds to the utterance intention.

Although the second server 300 expresses the response to the user's voice and the additional question in the text format and transmits the response and the additional question to the display apparatus 100 in the above exemplary embodiment, this is merely an example. The second server 300 may transmit information which relates to the response to the user's voice and the additional question to the display apparatus 100 so that the display apparatus 100 outputs the system response in any one or more of various forms.

Hereinafter, various exemplary embodiments will be described with reference to FIGS. 6A, 6B, 6C, 7A, 7B, 7C, 7D, 8A, 8B, 8C, 8D, 9A, 9B, 9C, and 9D. FIGS. 6A, 6B, 6C, 7A, 7B, 7C, 7D, 8A, 8B, 8C, 8D, 9A, 9B, 9C, and 9D are views which illustrate various examples by which the display apparatus 100 outputs an additional question as a system response based on an utterance intention of a user.

First, when an utterance intention of a user relates to a performance of a function of the display apparatus 100, a system response may include an additional question which relates to confirming whether to perform the function.

For example, it is assumed that the user utters “Initialize setting” as shown in FIG. 6A. In this case, the controller 150 may output a UI screen 610 which includes the text “Do you want to initialize all settings?” as a system response based on response information received from the second server 300, as shown in FIG. 6B.

Subsequently, when the user utters “Yes” as shown in FIG. 6C, the controller 150 may initialize all settings of the display apparatus 100 based on the response information received from the second server 300. The settings may include any or all settings that can be set in the display apparatus 100, such as, for example, favorite channel and/or screen setting.

Although the user utters “Initialize setting” with respect to the illustrations shown in FIGS. 6A, 6B, and 6C, this is merely an example. In particular, when an utterance intention of a user relates to a performance of a function of the display apparatus 100, such as, for example, “I will quit watching TV” and/or “I'd like to watch TV until 10 o'clock”, the controller 150 may output an additional question which relates to confirming whether to perform the function as a system response based on response information received from the second server 300.

Further, when an utterance intention of a user relates to a performance of a function of the display apparatus which function requires a performance of a prior function prior to performing the function, a system response may include an additional question which relates to the prior function. In particular, when an utterance intention of a user relates to a performance of a function of the display apparatus such as, for example, “Please set an alarm for 7 o'clock” and it is necessary to perform a prior function prior to performing the function of setting the alarm, the controller 150 may output an additional question which relates to the prior function as a system response.

The controller 150 may perform a function which corresponds to a user's voice which is received in response to the additional question such as, for example, “I will quit watching TV”, “I'd like to watch TV until 10 o'clock”, and “Please set an alarm for 7 o'clock”, based on response information received again from the second server 300. This has been described above with reference to FIG. 5 and a redundant explanation is omitted.

When an utterance intention of a user relates to a search for a content, a system response may include an additional question which relates to an anticipated result of searching for the content and/or an additional question which relates to a potential result of the searching.

Specifically, if an utterance intention of a user relates to an inquiry about a broadcast time of a first specific content, a system response may include an additional question which relates to at least one of a search for a broadcast time of the first specific content and a search for a second specific content which is similar to the first specific content.

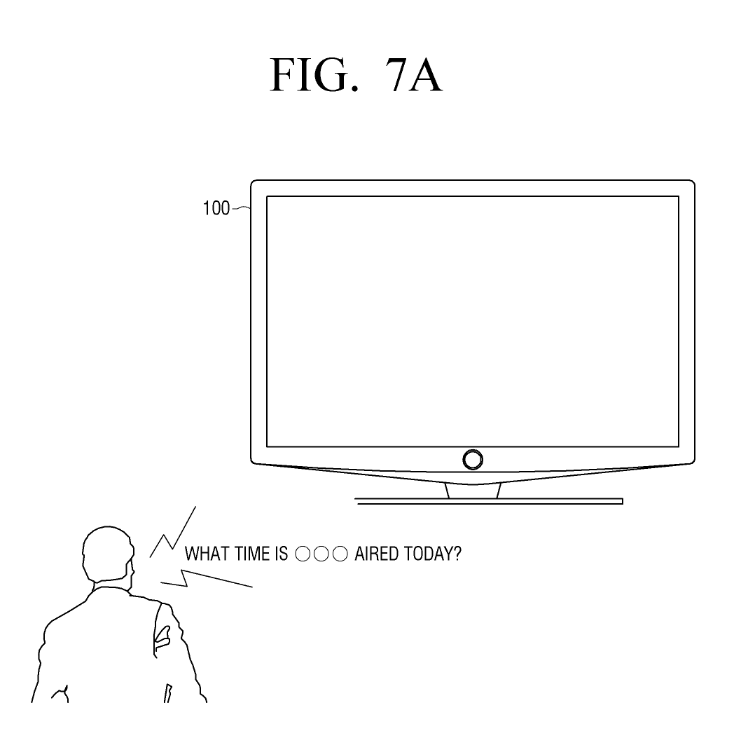

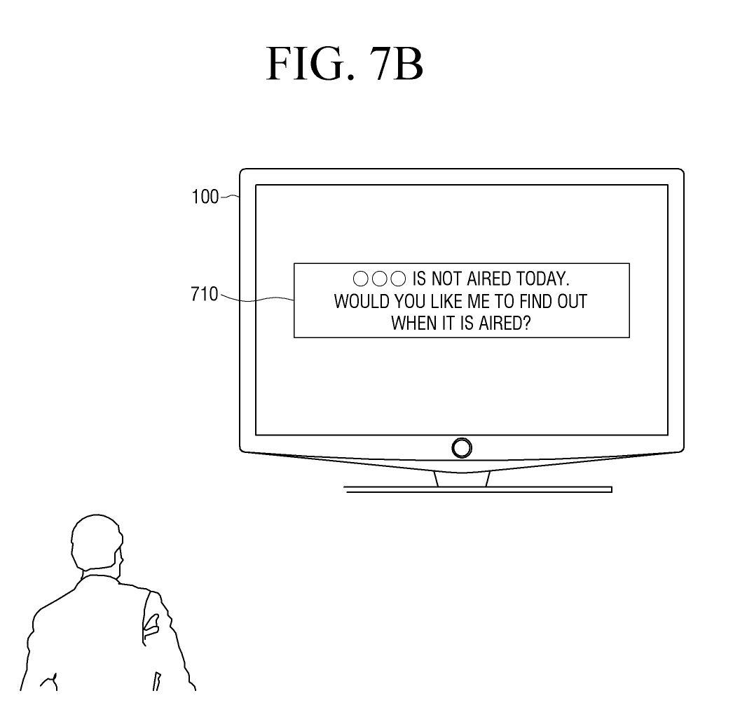

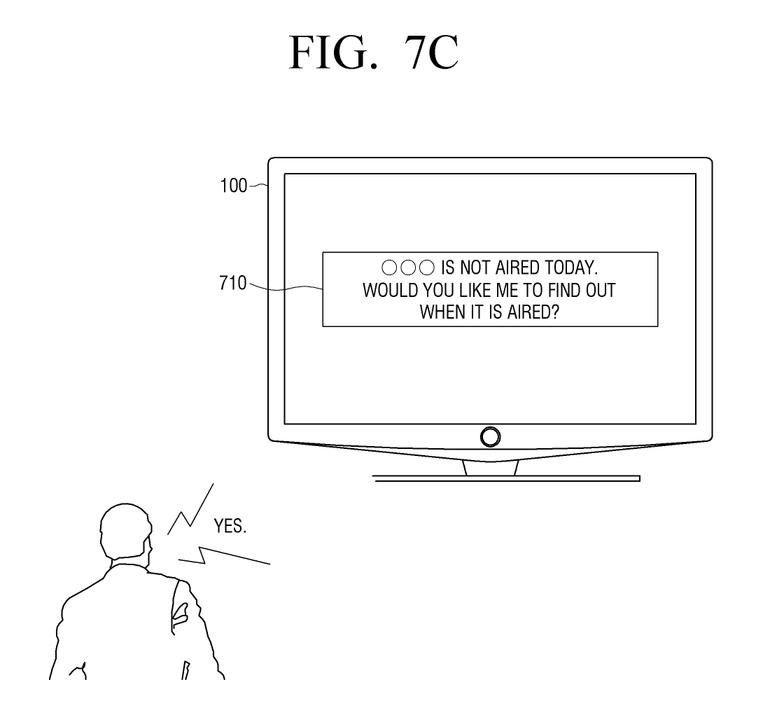

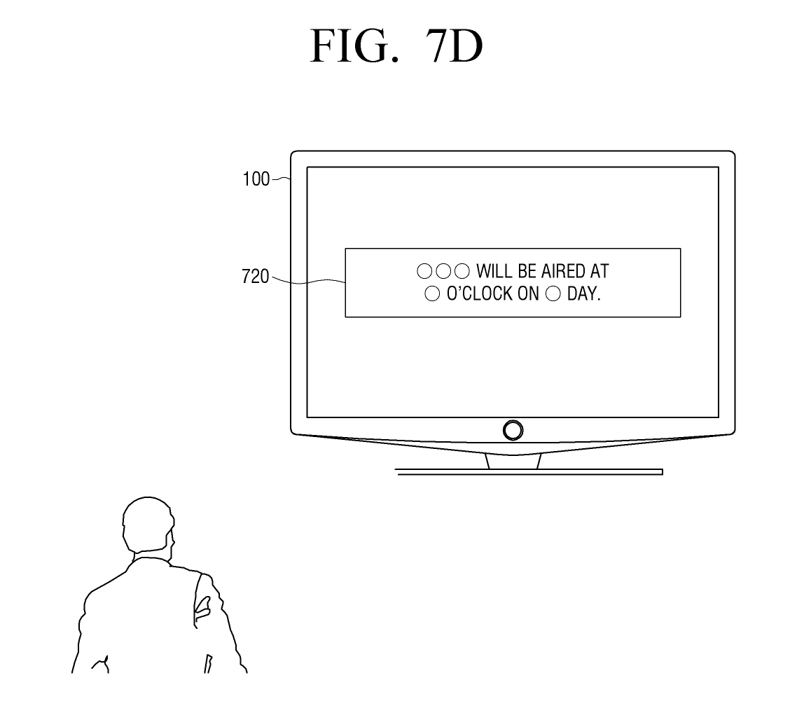

For example, it is assumed that the user utters “What time is ∘∘∘ (broadcast program name) aired today?” as shown in FIG. 7A. In this case, the controller 150 may output a UI screen 710 which includes the text “∘∘∘ is not aired today. Would you like me to find out when it is aired?” as a system response based on response information received from the second server 300, as shown in FIG. 7B.

Subsequently, when the user utters “Yes” as shown in FIG. 7C, the controller 150 may output a UI screen 720 which includes the text “∘∘∘ will be aired at ∘ o'clock on ∘ day” as a system response based on response information received from the second server 300, as shown in FIG. 7D.

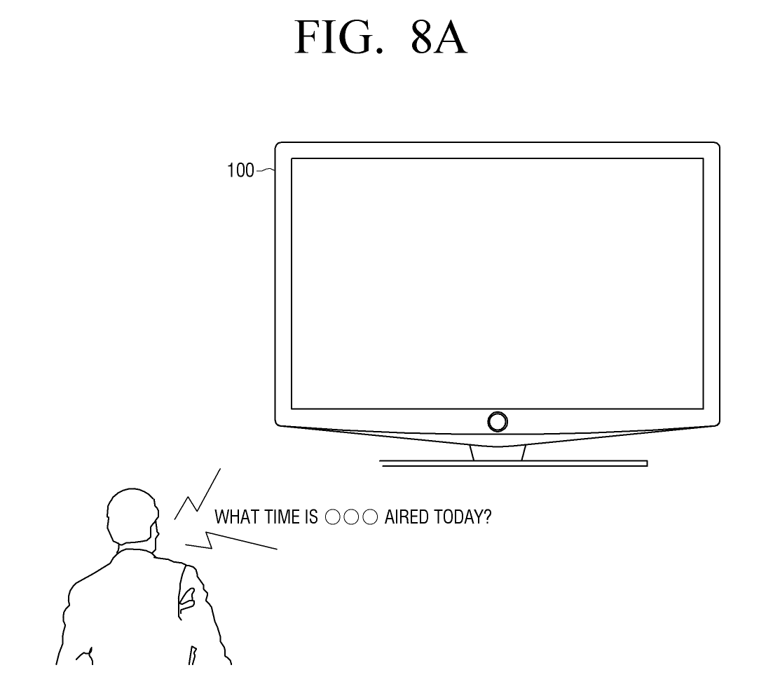

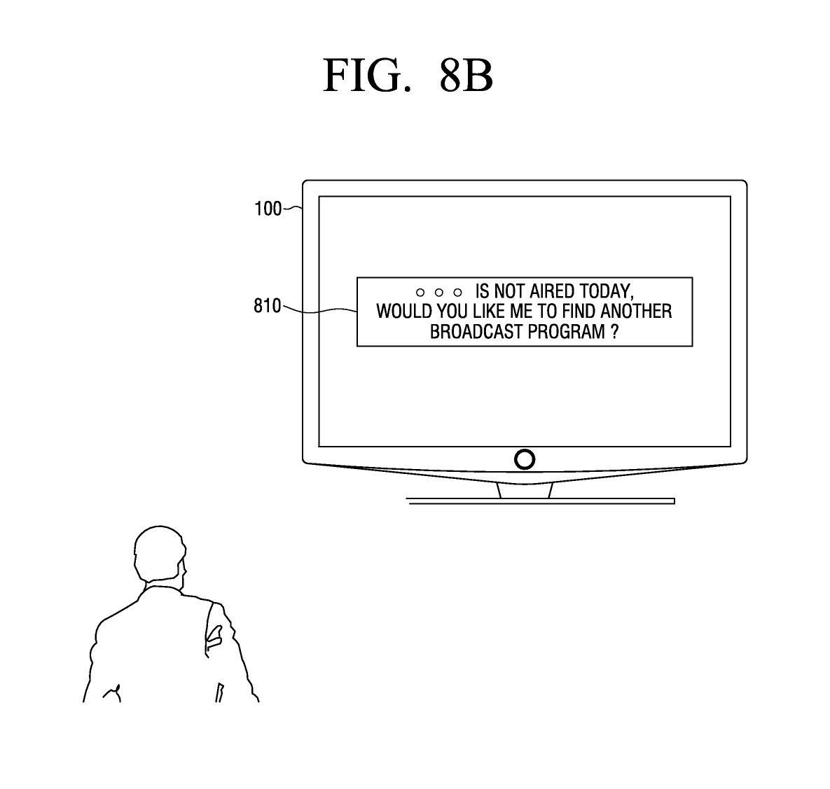

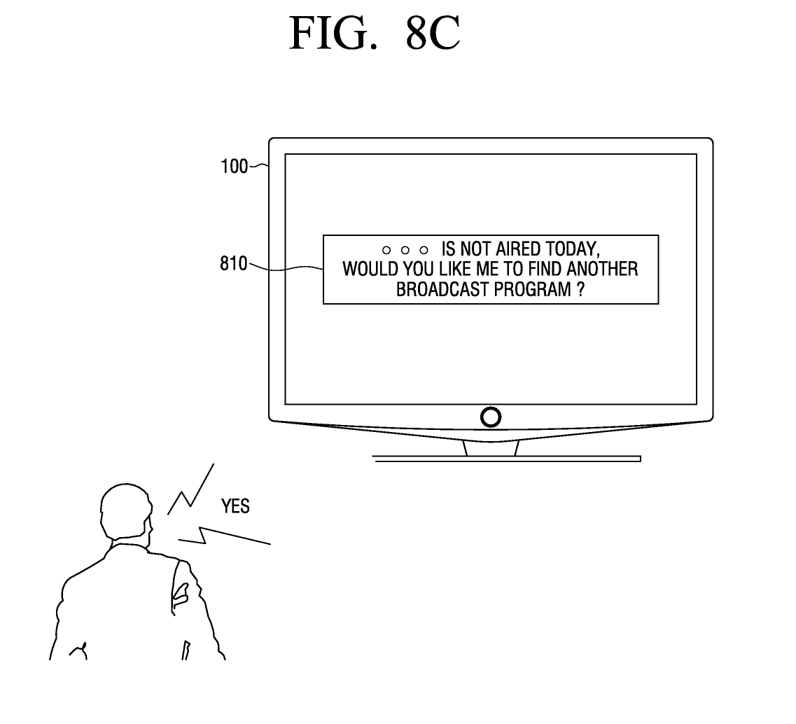

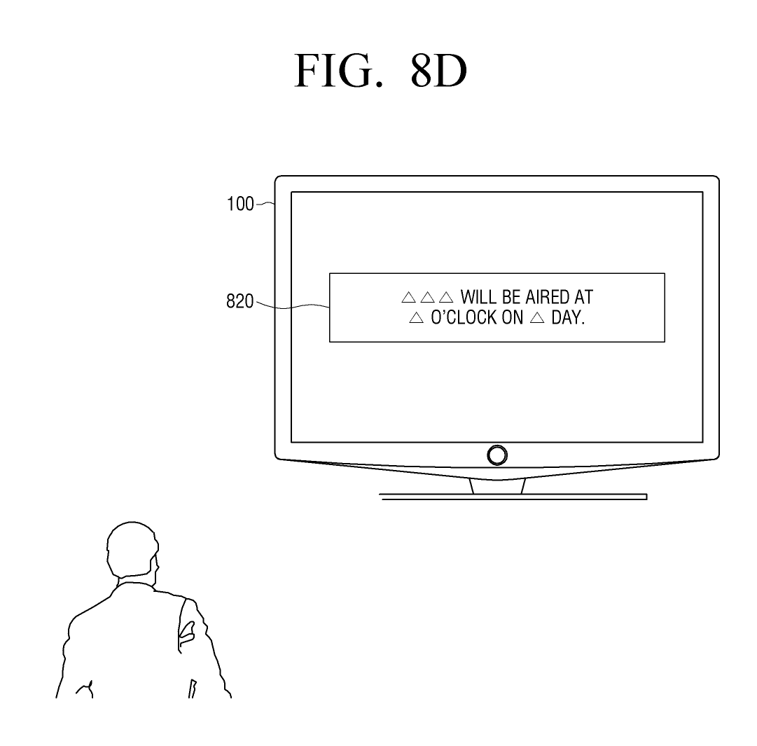

As another example, it is assumed that the user utters “What time is ∘∘∘ (broadcast program name) aired today?” as shown in FIG. 8A. In this case, the controller 150 may output a UI screen 810 which includes the text “∘∘∘ is not aired today. Would you like me to find another broadcast program?” as a system response based on response information received from the second server 300, as shown in FIG. 8B.

Subsequently, when the user utters “Yes” as shown in FIG. 8C, the controller 150 may output a UI screen 820 which includes the text “ΔΔΔ will be aired at Δ o'clock on Δ day.” as a system response based on response information received from the second server 300, as shown in FIG. 8D.

Further, if a search for a content relates to a search for a person which is related to a first specific content, a system response may include an additional question which relates to an inquiry about a search for a second specific content which is related to the person.

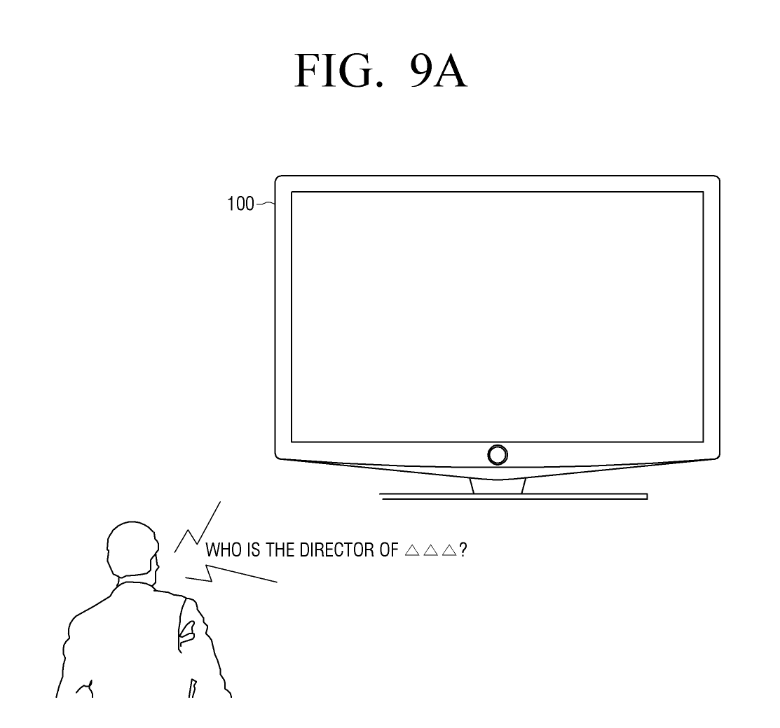

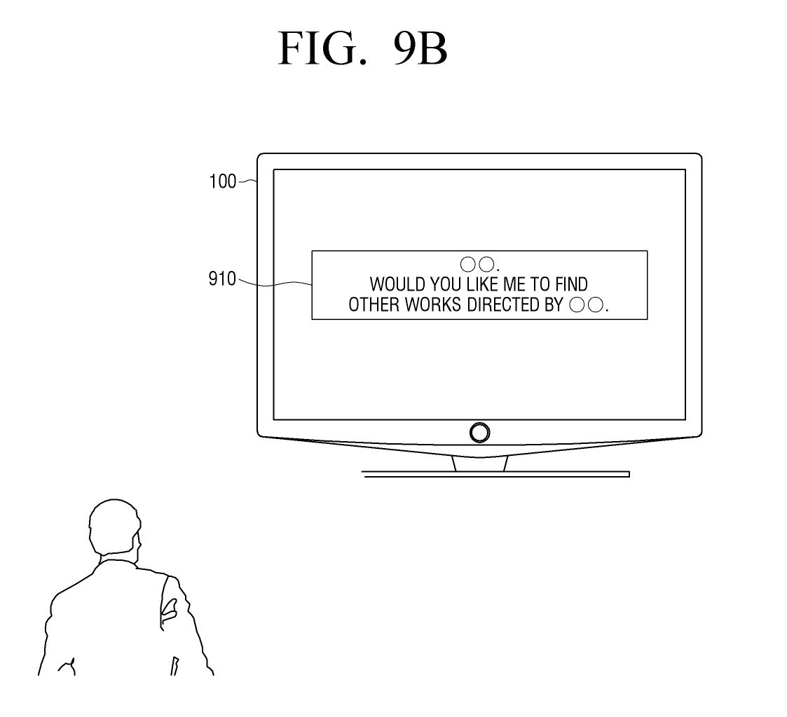

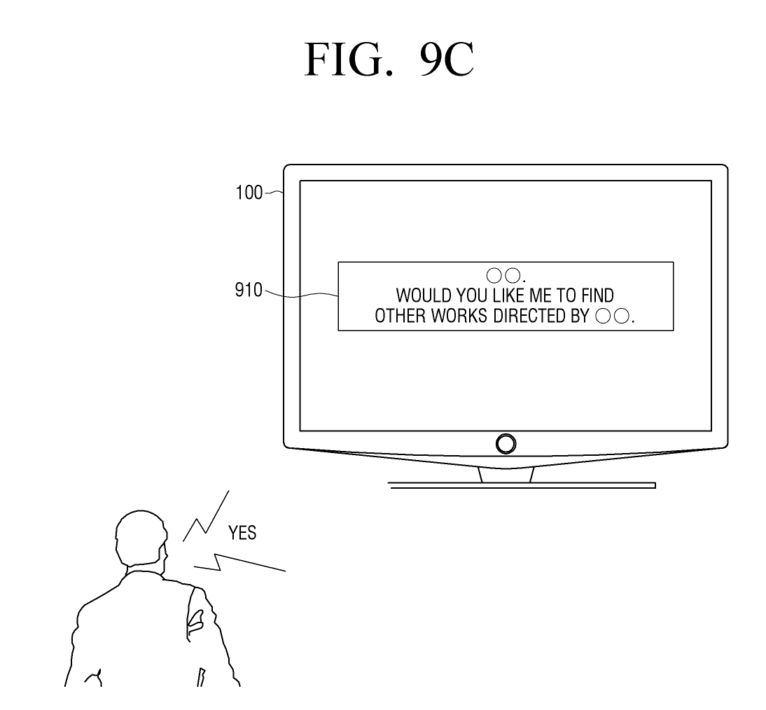

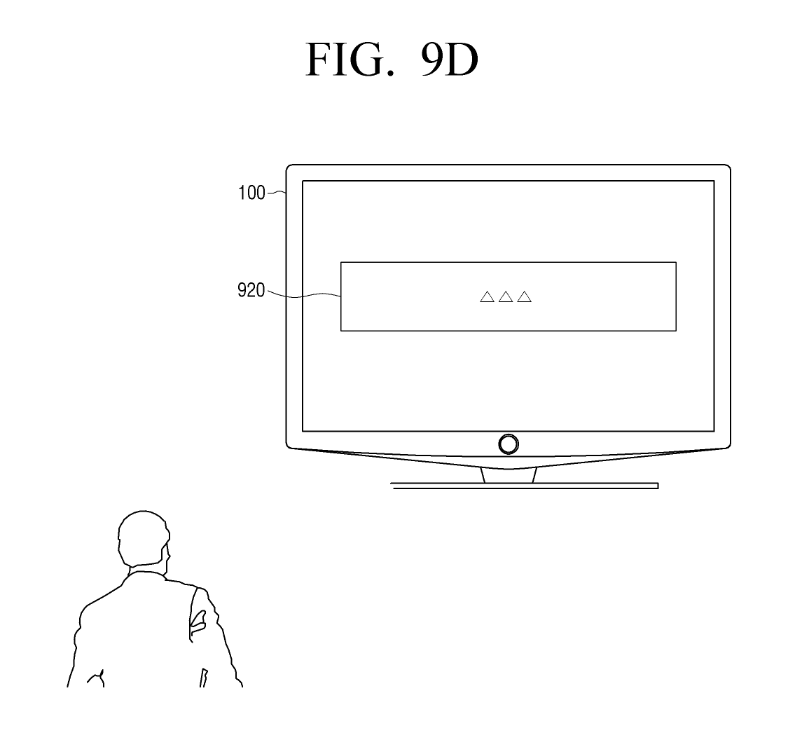

For example, it is assumed that the user utters “Who is the director of ΔΔΔ?” as shown in FIG. 9A. In this case, the controller 150 may output a UI screen 910 which includes the text “∘∘ (search director's name). Would you like me to find other works directed by ∘∘?” as a system response based on response information received from the second server 300, as shown in FIG. 9B.

Subsequently, when the user utters “Yes” as shown in FIG. 9C, the controller 150 may output a UI screen 920 which includes the text “ΔΔΔ (searched broadcast program name)” as a system response based on response information received from the second server 300, as shown in FIG. 9D.

Although it is assumed that the user utters “What time is ∘∘∘ (broadcast program name) aired today?” or “Who is the director of ∘∘∘ (broadcast program name)?” in FIGS. 7A, 7B, 7C, 7D, 8A, 8B, 8C, 8D, 9A, 9B, 9C, and 9D, this is merely an example. In particular, when an utterance intention of a user relates to a search for a content, such as, for example, “Please tune in to one of my favorite broadcast programs on ∘∘∘ (day)” or “Is ∘∘ (genre) aired on ∘∘ (channel name)?, the controller 150 may output an additional question which relates to confirming whether to perform a function as a system response based on response information received from the second server 300. In addition, the controller 150 may perform a function which corresponds to a user's voice which is received in response to the additional question, based on response information received again from the second server 300. This has been described above with reference to FIG. 5 and thus a redundant explanation is omitted.

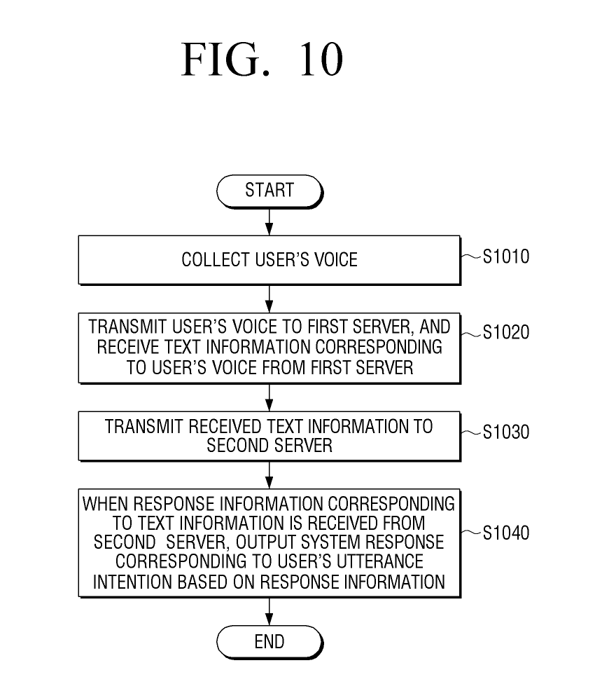

FIG. 10 is a flowchart which illustrates a method for controlling a display apparatus, according to an exemplary embodiment.

First, in operation S1010, a signal which relates to a user's voice and which includes voice information which is uttered by the user is collected.

Then, in operation S1020, the signal which relates to the user's voice is transmitted to the first server and text information which corresponds to the user's voice is received from the first server.

In operation S1030, the received text information is transmitted to the second server.

In operation S1040, when response information which corresponds to the text information is received from the second server, a system response which corresponds to an utterance intention of the user is output based on the response information. In this case, when the utterance intention of the user relates to at least one of a performance of a function of the display apparatus and a search for a content, the system response includes an additional question which relates to the at least one of the performance of the function and the search for the content, based on the utterance intention of the user.

Specifically, when the utterance intention of the user relates to a performance of a function of the display apparatus, the system response may include an additional question which relates to confirming whether to perform the function.

Further, when the utterance intention of the user relates to a performance of a function of the display apparatus which function requires a performance of a prior function prior to performing the function, the system response may include an additional question which relates to the prior function.

Still further, if the utterance intention of the user relates to a search for a content, the system response may include an additional question which relates to an anticipated result and/or a potential result of searching for the content.

Specifically, when a search for a content relates to an inquiry about a broadcast time of a first specific content, the system response may include an additional question which relates to at least one of a search for a broadcast time of the first specific content and a search for a content which is similar to the first specific content, such as, for example, a second specific content of the same genre as the first specific content. In addition, if a search for a content relates to a search for a person which is related to a first specific content, the system response may include an additional question which relates to a search for another content related to the person, such as, for example, a search for a second specific content which relates to the person.

Because the method for outputting an additional question of the display apparatus and detailed examples of the additional questions have been described above, a redundant explanation is omitted.

A non-transitory computer readable medium which stores a program for performing the controlling method according to the exemplary embodiments in sequence may be provided. The program is executable by using a computer.

The non-transitory computer readable medium refers to a physically realizable medium that stores data semi-permanently rather than storing data for a very short time, such as a register, a cache, and a memory, and is readable by an apparatus. Specifically, the above-described various applications or programs may be stored in a non-transitory computer readable medium such as a compact disc (CD), a digital versatile disk (DVD), a hard disk, a Blu-ray disk, a universal serial bus (USB) memory stick, a memory card, and a read only memory (ROM), and may be provided.

Although a bus is not illustrated in the above-described block diagrams of the display apparatus and the server, the elements of the display apparatus and the servers may communicate with one another through a bus. Further, each device may further include a processor, such as, for example, a central processing unit (CPU) and/or a microprocessor, in order to perform the above-described operations.

The foregoing exemplary embodiments and advantages are merely exemplary and are not to be construed as limiting the present inventive concept. The exemplary embodiments can be readily applied to other types of apparatuses. In addition, the description of the exemplary embodiments is intended to be illustrative, and not to limit the scope of the claims, and many alternatives, modifications, and variations will be apparent to those skilled in the art.

What is claimed is:

1. A display apparatus comprising:
an output unit;
a voice collector which is configured to collect a signal which relates to a user's voice;
a first communication unit which is configured to transmit the collected signal which relates to the user's voice to a first server and to receive text information which corresponds to the user's voice from the first server;
a second communication unit which is configured to transmit the received text information to a second server; and
a controller which, when response information which corresponds to the text information is received from the second server, is configured to control the output unit to output a system response which corresponds to an utterance intention of the user based on the response information,
wherein, when the utterance intention of the user relates to at least one of a performance of a function of the display apparatus and a search for a content, the system response comprises an additional question which relates to the at least one of the performance of the function and the search for the content.

2. The display apparatus as claimed in claim 1, wherein, when the utterance intention of the user relates to the performance of the function of the display apparatus, the additional question relates to confirming whether to perform the function.

3. The display apparatus as claimed in claim 1, wherein, when the utterance intention of the user relates to the performance of the function of the display apparatus which function requires a performance of a prior function prior to performing the function, the additional question relates to the performance of the prior function.

4. The display apparatus as claimed in claim 1, wherein, when the utterance intention of the user relates to the search for the content, the additional question relates to a potential result of the search for the content.

5. The display apparatus as claimed in claim 4, wherein, when the search for the content relates to an inquiry which relates to a broadcast time of a first specific content, the additional question relates to at least one of a search for the broadcast time of the first specific content and a search for a second specific content which is similar to the first specific content.

6. The display apparatus as claimed in claim 4, wherein, when the search for the content relates to a search for a person which relates to a first specific content, the additional question relates to a search for a second specific content which relates to the person.

7. A method for controlling a display apparatus, the method comprising:
collecting a signal which relates to a user's voice;
transmitting the collected signal which relates to the user's voice to a first server and receiving text information which corresponds to the user's voice from the first server;
transmitting the received text information to a second server; and
when response information which corresponds to the text information is received from the second server, outputting a system response which corresponds to an utterance intention of the user based on the response information,
wherein, when the utterance intention of the user relates to at least one of a performance of a function of the display apparatus and a search for a content, the system response comprises an additional question which relates to the at least one of the performance of the function and the search for the content.

8. The method as claimed in claim 7, wherein, when the utterance intention of the user relates to the performance of the function of the display apparatus, the additional question relates to confirming whether to perform the function.

9. The method as claimed in claim 7, wherein, when the utterance intention of the user relates to the performance of the function of the display apparatus which function requires a performance of a prior function prior to performing the function, the additional question relates to the performance of the prior function.

10. The method as claimed in claim 7, wherein, when the utterance intention of the user relates to the search for the content, the additional question relates to a potential result of the search for the content.

11. The method as claimed in claim 10, wherein, when the search for the content relates to an inquiry which relates to a broadcast time of a first specific content, the additional question relates to at least one of a search for the broadcast time of the first specific content and a search for a second specific content which is similar to the first specific content.

12. The method as claimed in claim 10, wherein, when the search for the content relates to a search for a person which relates to a first specific content, the additional question relates to a search for a second specific content which relates to the person.

13. A non-transitory computer-readable recording medium having recorded thereon a program which is executable by a computer for performing a method for controlling a display apparatus, the method comprising:
collecting a signal which relates to a user's voice;
transmitting the collected signal which relates to the user's voice to a first server and receiving text information which corresponds to the user's voice from the first server;
transmitting the received text information to a second server; and
when response information which corresponds to the text information is received from the second server, outputting a system response which corresponds to an utterance intention of the user based on the response information,
wherein, when the utterance intention of the user relates to at least one of a performance of a function of the display apparatus and a search for a content, the system response comprises an additional question which relates to the at least one of the performance of the function and the search for the content.

14. The non-transitory computer-readable recording medium as claimed in claim 13, wherein, when the utterance intention of the user relates to the performance of the function of the display apparatus, the additional question relates to confirming whether to perform the function.

15. The non-transitory computer-readable recording medium as claimed in claim 13, wherein, when the utterance intention of the user relates to the performance of the function of the display apparatus which function requires a performance of a prior function prior to performing the function, the additional question relates to the performance of the prior function.

16. The non-transitory computer-readable recording medium as claimed in claim 13, wherein, when the utterance intention of the user relates to the search for the content, the additional question relates to a potential result of the search for the content.

17. The non-transitory computer-readable recording medium as claimed in claim 16, wherein, when the search for the content relates to an inquiry which relates to a broadcast time of a first specific content, the additional question relates to at least one of a search for the broadcast time of the first specific content and a search for a second specific content which is similar to the first specific content.

18. The non-transitory computer-readable recording medium as claimed in claim 16, wherein, when the search for the content relates to a search for a person which relates to a first specific content, the additional question relates to a search for a second specific content which relates to the person.
